(19) United States
(12) Patent Application Publication
(10) Pub. No.: US 2002/0143907 A1
(43) Pub. Date: Oct. 3, 2002

(54) Data acquiring apparatus, downloading server and trigger server

(75) Inventor: Ken Tsurubayashi, Tokyo (JP)

Correspondence Address: GREENBLUM & BERNSTEIN, P.L.C., 1941 ROLAND CLARKE PLACE, RESTON, VA, 20191, US

(73) Assignee: Matsushita Electric Industrial Co., Ltd., Osaka (JP)

(21) Appl. No.: 10/108,454

(22) Filed: Mar. 29, 2002

(30) Foreign Application Priority Data
Mar. 30, 2001 (JP) JP2001-100233

(51) Int. Cl. G06F 15/177

(52) U.S. Cl. 709/221

(57) ABSTRACT

Data acquiring apparatus 10 that acquires data, downloading server 50 that transmits the data, and trigger server 80 that instructs the data acquiring apparatus to acquire the data from the downloading server are connected via network 2, and downloading server 50 provides an instruction to trigger server 80 via network 3. The data acquiring apparatus has a holding section that holds a server address, a communication starting trigger section that detects trigger information from the trigger server and triggers a start of communications with the server, a communication control section that receives the notification to start communicating with the server, and a data storing section that stores data acquired via the communications. The data acquiring apparatus operates to acquire the data by itself, and therefore is capable of acquiring the data safely.

### BACKGROUND OF THE INVENTION

1. Field of the Invention

The present invention relates to a data acquiring apparatus that acquires software of information home appliances or the like via a network, a downloading server that provides the data to the data acquiring apparatus, a trigger server that notifies the data acquiring apparatus of a time of acquiring the data, and a system composed of the apparatus and servers, particularly, so as to enable the data acquiring apparatus to acquire the data safely.

2. Description of the Related Art

Recently significant advances have been made in intelligence in home-appliance products. For example, there are microwave ovens with recipes stored therein for controlling heating time in accordance with the recipes, washing machines that adjust the time of washing and rinsing corresponding to stains of clothing, and refrigerators that guide foods stored therein by speech; the list is endless. In these products, an internal CPU executes the predetermined processing according to software stored in a memory. Such an operation is the same as in products performing more complicated operations such as STB (Set-Top Box) called an information home appliance connected with a television, high-performance facsimile, and cellular telephone.

When a bug is found in the software of such a non-PC apparatus (one of apparatuses except personal computers), it is generally performed that the products are once collected, and the software is switched to return to users, or service people visit users and exchange a memory with the software stored therein of the product.

In STB, a system is considered in which data of the software is broadcast, and STB having received the data switches the software stored in STB.

However, exceedingly significant burdens are placed on the cases that products are collected to exchange the software or service people visit users. In contrast thereto, a system is capable of achieving a reduced burden in which a server transmits software by broadcast or network so as to automatically exchange the software of apparatuses. However, a fear is expected in this system that a malicious third party pretending to be an authorized server transmits unauthorized software to non-PC apparatuses to cause confusion in operations of the apparatuses.

### SUMMARY OF THE INVENTION

It is an object of the present invention to provide a data acquiring apparatus capable of acquiring, safely via a network, data for updating software of a non-PC apparatus, a downloading server that transmits the data, a trigger server that instructs the data acquiring apparatus to acquire the data, and a system composed of the apparatus and servers.

In order to achieve the object, the data acquiring apparatus of the present invention is installed in a non-PC apparatus connected to a network, acquires update data via the network from a downloading server, and is provided with a data holding section that holds data for operating the non-PC apparatus, a requesting section that requests the downloading server to transmit the update data, an acquiring section that acquires the update data transmitted from the downloading server in response to the request, a trigger section that inputs a communication starting trigger to the request section, and an update section that updates the data held in the data holding section to the update data acquired by the acquiring section.

Further, the downloading server of the present invention transmits the update data to the non-PC apparatus via the network, and is provided with a receiving section that receives an update data request transmitted from the non-PC apparatus, a storing section that stores the update data, a reading section that reads from the storing section the update data corresponding to the non-PC apparatus having transmitted the update data request, and a transmitting section that transmits the update data read in the reading section to the non-PC apparatus having transmitted the update data request.

Furthermore, the trigger server of the present invention instructs via the network the non-PC apparatus to acquire the update data from the downloading server, and is provided with a detecting section that detects that the update data is stored in the downloading server, and a trigger information transmitting section that transmits trigger information for instructing to acquire the update data from the downloading server to the non-PC apparatus needing to acquire the update data when the detecting section detects the update data is stored in the downloading server.

Accordingly, the data acquiring apparatus is capable of safely acquiring the data for updating the software of the non-PC apparatus from the downloading server via the network. Further, the downloading server efficiently transmits the data to the data acquiring apparatus in cooperation with the trigger server.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a diagram of a configuration of a system according to embodiments of the present invention;

FIG. 2 is a block diagram illustrating a configuration of a data acquiring apparatus in a first embodiment;

FIG. 3 is a functional block diagram of a communication control section in the first embodiment;

FIG. 4 is a functional block diagram of a communication starting trigger section in the first embodiment;

FIG. 5 is a functional block diagram of a trigger notification control section in the first embodiment;

FIG. 6 is a diagram showing a data format of read request communication data in the first embodiment;

FIG. 7 is a functional block diagram of a communication starting trigger section in a second embodiment;

FIG. 8 is a functional block diagram of a communication starting trigger section in a third embodiment;

FIG. 9 is a diagram showing a data format of trigger information in the third embodiment;

FIG. 10 is a functional block diagram of a trigger information detecting section in the third embodiment;

FIG. 11 is a functional block diagram of a trigger information determination control section in the third embodiment;

FIG. 12 is a diagram showing a data format of second trigger information in the third embodiment;

FIG. 13 is a functional block diagram of a second trigger information detecting section in the third embodiment;

FIG. 14 is a diagram showing a data format of third trigger information in the third embodiment;

FIG. 15 is a functional block diagram of a third trigger information detecting section in the third embodiment;

FIG. 16 is a block diagram illustrating a configuration of a data acquiring apparatus in a fourth embodiment;

FIG. 17 is a functional block diagram of a communication control section in the fourth embodiment;

FIG. 18 is a diagram showing a data format of trigger information in the fourth embodiment;

FIG. 19 is a functional block diagram of a trigger information detecting section in the fourth embodiment;

FIG. 20 is a functional block diagram of a second communication control section in the fourth embodiment;

FIG. 21 is a block diagram illustrating a configuration of a data acquiring apparatus in a fifth embodiment;

FIG. 22A is a diagram illustrating a configuration of a media interface section in the fifth embodiment;

FIG. 22B is a diagram illustrating a configuration of a media interface section in the fifth embodiment;

FIG. 23 is a block diagram illustrating another configuration of the data acquiring apparatus in the fifth embodiment;

FIG. 24 is a block diagram illustrating a data acquiring apparatus in a sixth embodiment;

FIG. 25 is a functional block diagram of an update control section in the sixth embodiment;

FIG. 26 is a diagram to explain values stored in a state holding section in the sixth embodiment;

FIG. 27 is a diagram illustrating a configuration of an auxiliary power supplying section in the sixth embodiment;

FIG. 28 is a block diagram illustrating a downloading server in a seventh embodiment;

FIG. 29 is a table showing data held in a model/data correspondence managing section in the seventh embodiment;

FIG. 30 is a functional block diagram of a control section in the seventh embodiment;

FIG. 31 is a diagram showing a data format of write request communication data in the seventh embodiment;

FIG. 32 is a block diagram illustrating another configuration of the downloading server in the seventh embodiment;

FIG. 33 is a table showing data held in an apparatus-model correspondence managing section in the seventh embodiment;

FIG. 34 is a diagram showing a data format of read request communication data in the seventh embodiment;

FIG. 35 is a block diagram illustrating a configuration of a downloading server in an eighth embodiment;

FIG. 36 is a block diagram illustrating another configuration of the downloading server in the eighth embodiment;

FIG. 37 is a table showing data held in an apparatus/location correspondence managing section in the eighth embodiment;

FIG. 38 is a table showing data held in an area/server correspondence managing section in the eighth embodiment;

FIG. 39 is a table showing second data held in the apparatus/location managing section in the eighth embodiment;

FIG. 40 is a table showing second data held in the area/server correspondence managing section in the eighth embodiment;

FIG. 41 is a table showing third data held in the apparatus/location managing section in the eighth embodiment;

FIG. 42 is a table showing third data held in the area/server correspondence managing section in the eighth embodiment;

FIG. 43 is a block diagram illustrating a configuration of a downloading server in a ninth embodiment;

FIG. 44 is a diagram illustrating data held in a read date/time storing section in the ninth embodiment;

FIG. 45 is a block diagram illustrating a second configuration of the downloading server in the ninth embodiment;

FIG. 46 is a table showing data held in a write date/time storing section in the ninth embodiment;

FIG. 47 is a block diagram illustrating a third configuration of the downloading server in the ninth embodiment;

FIG. 48 is a diagram showing a data format of write request communication data in the ninth embodiment;

FIG. 49 is a block diagram illustrating a fourth configuration of the downloading server in the ninth embodiment;

FIG. 50 is a table showing data held in a data storing section in the ninth embodiment;

FIG. 51 is a block diagram illustrating a fifth configuration of the downloading server in the ninth embodiment;

FIG. 52 is a table showing data held in an individual apparatus information storing section in the ninth embodiment;

FIG. 53 is a block diagram illustrating a configuration of a trigger server in a tenth embodiment;

FIG. 54 is a table showing data held in an individual apparatus address storing section in the tenth embodiment;

FIG. 55 is a functional block diagram of a control section in the tenth embodiment;

FIG. 56 is a block diagram illustrating a configuration of a trigger server in an eleventh embodiment;

FIG. 57 is a block diagram illustrating a configuration of a trigger server in a twelfth embodiment;

FIG. 58 is a table showing data held in an individual apparatus address storing section in the twelfth embodiment;

FIG. 59 is a block diagram illustrating a configuration of a trigger server in a thirteenth embodiment;

FIG. 60 is a diagram showing a data format of write request communication data in the thirteenth embodiment;

FIG. 61 is a diagram showing a data format of write request communication data in a fourteenth embodiment; and

FIG. 62 is a block diagram illustrating a configuration of a trigger server in the fourteenth embodiment.

### DETAILED DESCRIPTION OF THE PREFERRED EMBODIMENTS

Embodiments of the present invention will be described below with reference to accompanying drawings.

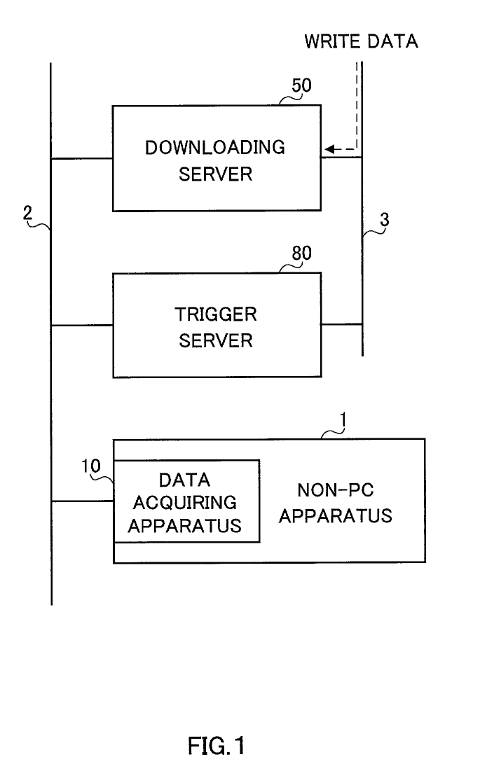

As illustrated in FIG. 1, a system of the embodiments of the present invention is provided with data acquiring apparatus 10 that acquires update data of software of non-PC apparatus 1 via network 2, downloading server 50 that provides the update data via network 2, and trigger server 80 that instructs data acquiring apparatus 10 to acquire the update data.

The update data is written into downloading server 50 via second network (LAN) 3, and downloading server 50 transmits information of the written data to trigger server 80 via LAN 3.

In the system, data acquiring apparatus 10 requests data to downloading server 50, and when there is data to be sent, downloading server 50 writes the data into data acquiring apparatus 10. Downloading server 50 does not voluntarily transfer the data to data acquiring apparatus 10. It is because providing a path for downloading server 50 to directly transfer data to data acquiring apparatus 10 causes a possibility that a malicious user transfers improper software and/or data to data acquiring apparatus 10 via such a path.

Data acquiring apparatus 10 requests update data to downloading server 50 at a predetermined time every day, or requests data to downloading server 50 at predetermined intervals. This case eliminates the need of trigger server 80.

Further when data acquiring apparatus 10 receives trigger information from trigger server 80 that detects that update data is written into downloading server 50, the apparatus 10 requests the update data to downloading server 50.

Non-PC apparatus 1 includes various apparatuses such as a microwave oven, washing machine, refrigerator, STB, facsimile and cellular telephone, and the update data includes data of software for specifying the latest function, recipe or the like of non-PC apparatus 1, and of software with a bug corrected.

In the following, first to sixth embodiments explain configurations and operations of data acquiring apparatus 10, seventh to ninth embodiments explain configurations and operations of downloading server 50, and tenth to fourteenth embodiments explain configurations and operations of trigger server 80.

(First Embodiment)

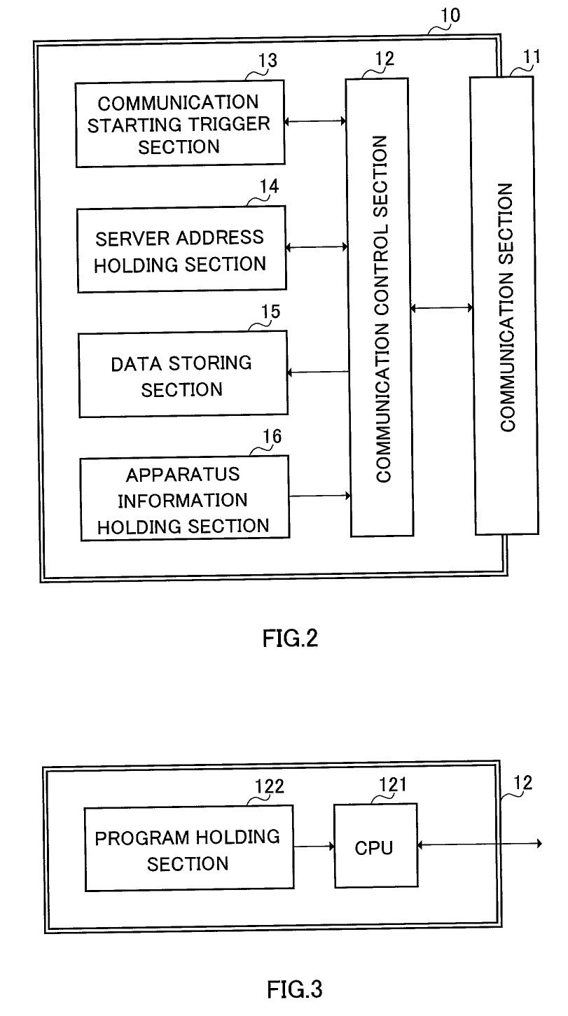

As illustrated in FIG. 2, data acquiring apparatus 10 in the first embodiment is provided with communication section 11 that is connected to network 2 to transmit and receive electronic data, server address holding section 14 that holds an address for identifying downloading server 50 over network 2, communication starting trigger section 13 that triggers starting communications with downloading server 50, communication control section 12 that receives a notification from communication starting trigger section 13, acquires a server address from server address holding section 14, and performs communications with downloading server 50 with the address, data storing section 15 that stores electronic data that communication control section 12 acquires via communications with downloading server 50, and apparatus information holding section 16 that holds information on non-PC apparatus 1 and data acquiring apparatus 10.

Data acquiring apparatus 10 is assembled in non-PC apparatus 1 with each section mounted on a substrate.

As illustrated in FIG. 3, communication control section 12 is provided with CPU 121, and program holding section 122 that holds a program for specifying the operation of CPU 121.

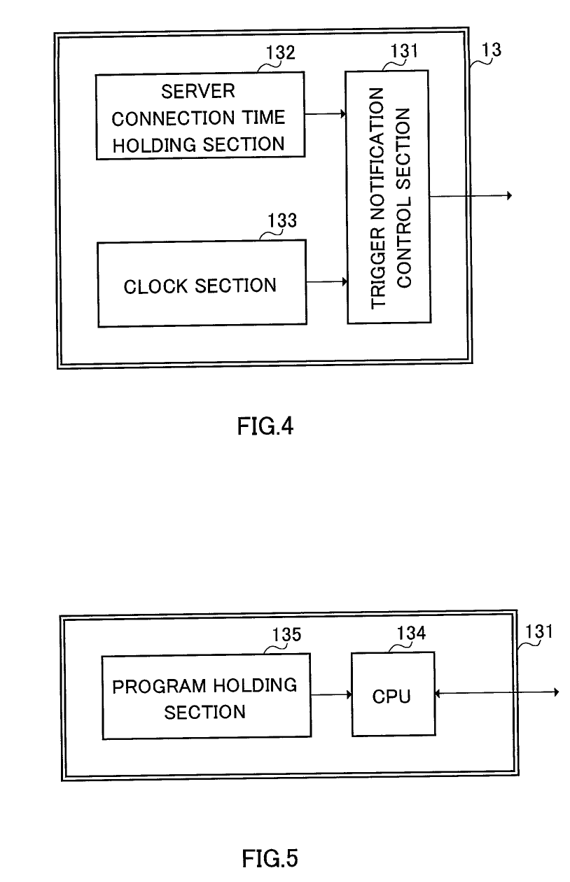

As illustrated in FIG. 4, communication starting trigger section 13 is provided with a server connection time holding section 132 that stores at least one time of transmitting a data read request to downloading server 50, clock section 133 that records a current time, and trigger notification control section 131 that compares the current time with the time held in server connection time holding section 132, and when the times are coincident with each other, outputs a trigger notification. As illustrated in FIG. 5, trigger notification control section 131 is provided with CPU 134 and program holding section 135 that holds a program for specifying the operations of CPU 134.

Apparatus information holding section 16 holds information including a model, serial number and model number of non-PC apparatus 1, and an IP address of data acquiring apparatus 10.

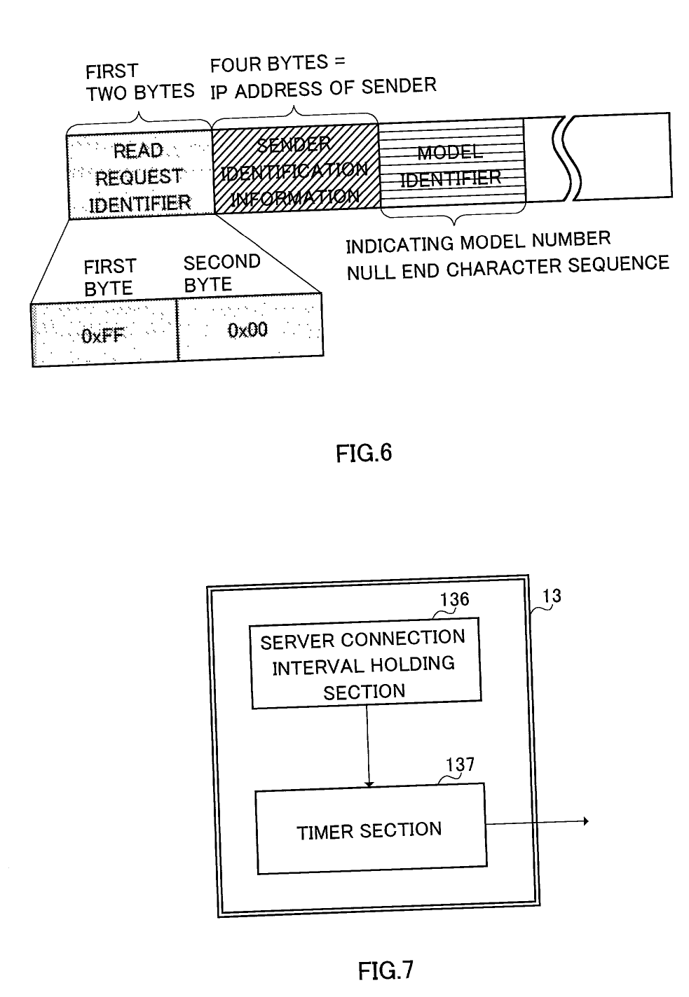

In the apparatus, communication starting trigger section 13 outputs the trigger notification to communication control section 12 when the time held in server connection time holding section 132 is coincident with the current time. In response to the notification, as illustrated in FIG. 6, communication control section 12 generates read request communication data containing a read request identifier, the IP address (sender identification information) read from apparatus information holding section 16, and model number (model identifier), acquires the address of downloading server 50 from server address holding section 14, and transmits the read request communication data to downloading server 50 to communication section 11.

As described later, when holding update data for a corresponding model, downloading server 50 transfers the update data to the IP address, as a destination, of the sender identification information contained in the read request communication data via network 2.

Data acquiring apparatus 10 having received the data stores the data in data storing section 15.

Thus, data acquiring apparatus 10 requests update data to downloading server 50 at a predetermined time, and when downloading server 50 holds the update data, acquires the data.

In addition, when data acquiring apparatus 10 places a call to downloading server 50 and downloading server 50 transfers the update data to data acquiring apparatus 10 via a connected telephone channel, it is not necessary for the read request communication data to contain the sender identification information.

(Second Embodiment)

Data acquiring apparatus 10 of the second embodiment requests update data to downloading server 50 at predetermined time intervals.

As illustrated in FIG. 7, communication starting trigger section 13 of the apparatus of this embodiment is provided with server connection interval holding section 136 that holds a time interval to start connecting to the downloading server, and timer section 137 that notifies the expiration of a time for which the section 137 is set. The configuration is the same as in the first embodiment (FIG. 2) except the foregoing.

Timer section 137 in communication starting trigger section 13 of the apparatus outputs a signal whenever the time held in server connection interval holding section 136 elapses, and communication starting trigger section 13 outputs the signal from timer section 137 to communication control section 12 as a trigger for starting communications. The operation is the same as in the first embodiment except the foregoing.

This data acquiring apparatus 10 requests update data to downloading server 50 at predetermined intervals, and when downloading server 50 holds the update data, acquires the data.

(Third Embodiment)

Data acquiring apparatus 10 of the third embodiment requests update data to downloading server 50 when the apparatus 10 receives trigger information from trigger server 80.

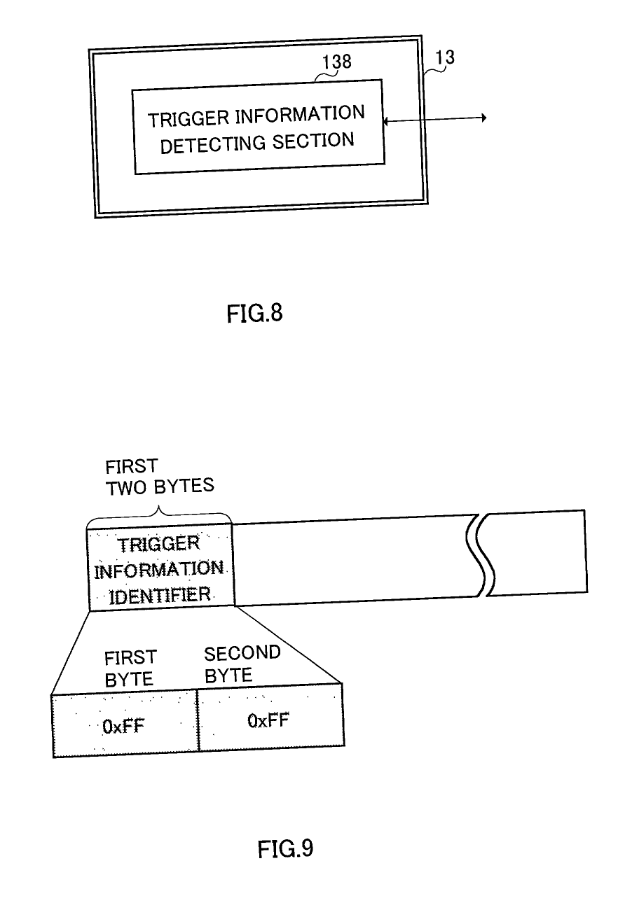

As illustrated in FIG. 8, communication starting trigger section 13 of the apparatus of this embodiment is provided with trigger information detecting section 138 that detects trigger information for instructing to access to downloading server 50 from the electronic data received in communication section 11 and notifies the information. The configuration is the same as in the first embodiment (FIG. 1) except the foregoing.

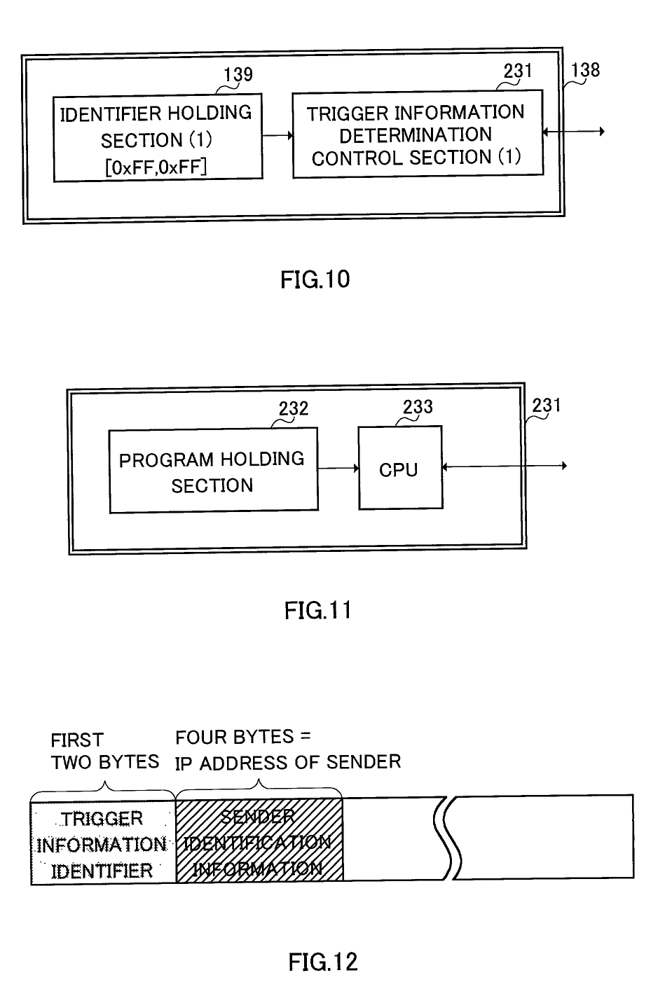

As illustrated in FIG. 9, the trigger information transmitted from trigger server 80 contains the trigger information identifier in first two bytes. As illustrated in FIG. 10, trigger information detecting section 138 is provided with identifier holding section (1) 139 that holds an identifier of the trigger information, and trigger information determination control section (1) 231 that examines whether or not the trigger information identifier exists at the beginning of the electronic data received in communication section 11, and determines whether or not the electronic data is the trigger information. As illustrated in FIG. 11, trigger information determination control section (1) 231 is provided with CPU 233 and program holding section 232 that holds a program for specifying the operation of CPU 233.

When the same identifier as that of the trigger information held in identifier holding section (1) 139 exists at the beginning of the data received from network 2, communication starting trigger section 13 of the apparatus of this embodiment identifies the data as the trigger information, and outputs a trigger for starting communications to communication control section 12. The operation thereafter is the same as in the first embodiment.

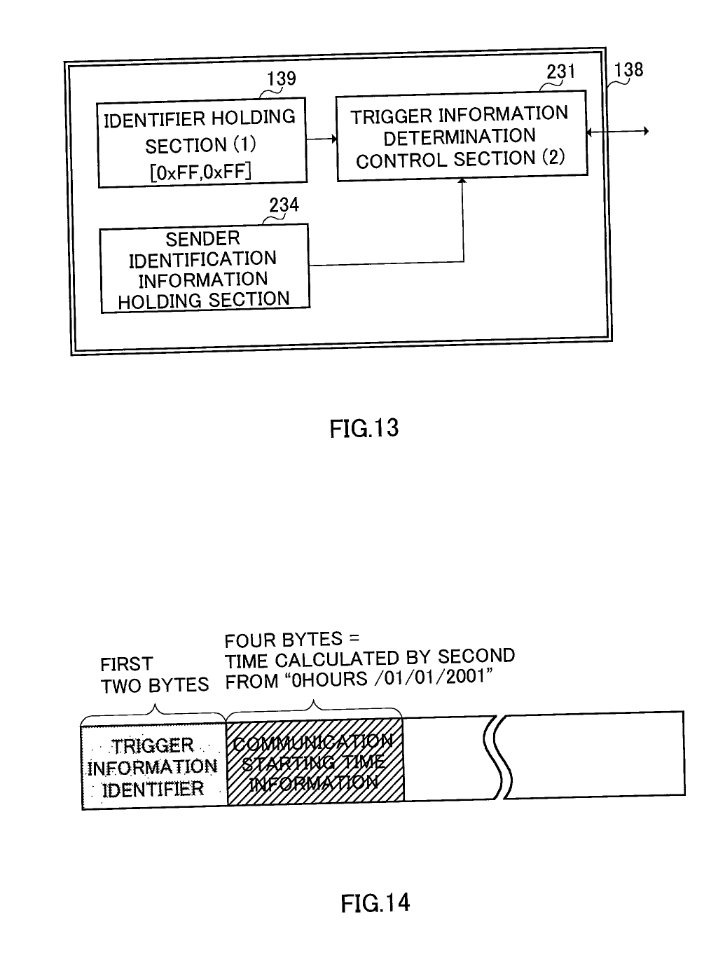

Further, as illustrated in FIG. 12, trigger server 80 may add an IP address of the sender (trigger server 80), as sender identification information, to the trigger information. In this case, as illustrated in FIG. 13, trigger information detecting section 138 is provided with sender identification information holding section 234, in addition to identifier holding section (1) 139 and trigger information determination control section (2) 231. When the trigger information identifier exists at the beginning of the received electronic data and the electronic data contains the sender identification information held in sender identification information holding section 234, trigger information determination control section (2) 231 identifies the electronic data as the trigger information, and outputs a trigger for starting communications.

Furthermore, trigger server 80 may encrypt the sender identification information to add to the trigger information. In this case, trigger information determination control section (2) 231 decodes the sender identification information contained in the received data using a decoding key held in sender identification information holding section 234, and identifies whether or not the decoded result is coincident with the sender identification information held in sender identification information holding section 234.

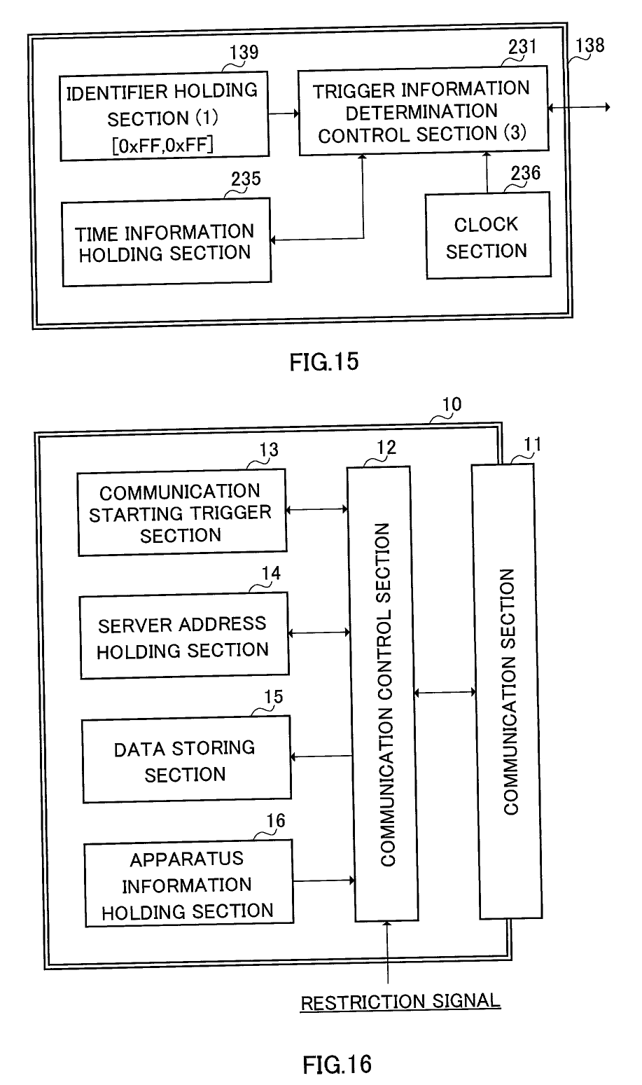

Moreover, as illustrated in FIG. 14, trigger server 80 may add communication starting time information indicative of a time of starting communications with downloading sever 50 to the trigger information. The communication starting time information contains information of a time calculated by second stating from a time that is predetermined, as a starting time common to the system, between the downloading server, trigger server and data acquiring apparatus. In this case, as illustrated in FIG. 15, trigger information detecting section 138 is provided with time information holding section 235 that holds the communication starting time information contained in the trigger information, and clock section 236 that records the current time, in addition to identifier holding section (1) 139 and trigger information determination control section (3) 231. The section (3) 231 acquires the communication starting time information from the received data identified as the trigger information to store in time information holding section 235, and when the current time is coincident with the communication starting time, outputs a trigger for starting communications.

Thus, this data acquiring apparatus 10 requests update data to downloading server 50 at the time of receiving the trigger information or at the time designated by the trigger information, and acquires the update data from downloading server 50.

(Fourth Embodiment)

Data acquiring apparatus of the fourth embodiment delays the starting time of acquiring update data corresponding to an operation status of non-PC apparatus 1.

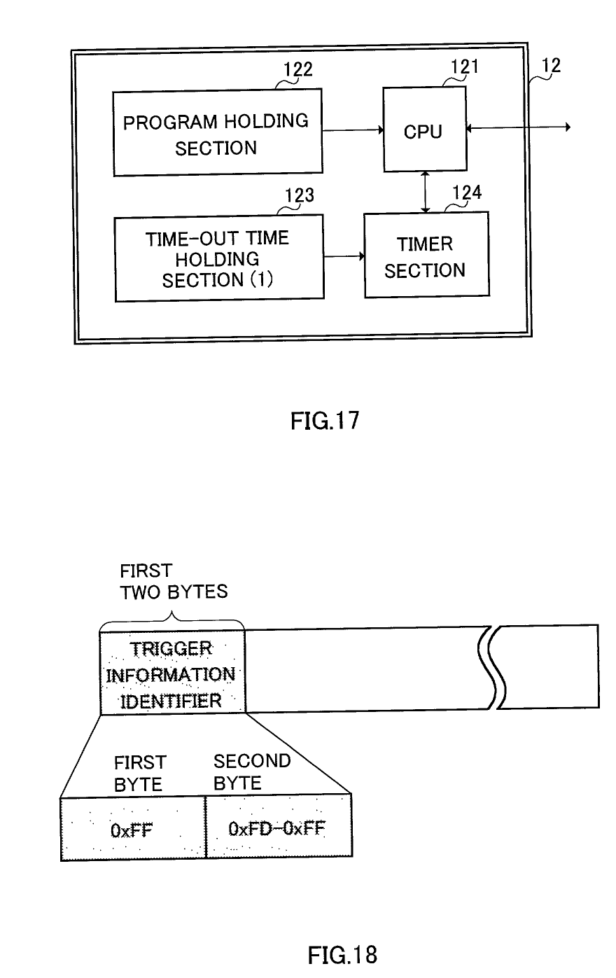

In this data acquiring apparatus 10, as illustrated in FIG. 16, communication control section 12 receives as its input a communication starting restriction signal for restricting the start of communications with downloading server 50. The configuration is the same as in the first embodiment (FIG. 2) except the foregoing.

When communication control section 12 of the apparatus receives the notification from communication starting trigger section 13, the section 12 starts communications with downloading server 50 unless the communication starting restriction signal is active. When the restriction signal is active, the section 12 suspends the start of communications with downloading server 50 until the restriction signal is not active, and starts communications when the restriction signal is not active.

Thus, by delaying the time of starting communications with downloading server 50 based on the communication starting restriction signal, it is possible to avoid communications with downloading server 50 during a period of time non-PC apparatus 1 is operating.

FIG. 17 illustrates a configuration for providing a suspending time for starting communications with downloading server 50 with an upper limit. Communication control section 12 of this apparatus is provided with time-out time holding section (1) 123 that holds an upper limit of the suspending time and timer section 124 that notifies the expiration of a time for which the section 124 is set, in addition to CPU 121 and program holding section 122.

At the time of receiving the notification from communication starting trigger section 13, when the communication starting restriction signal is active, communication control section 12 acquires the time-out time from time-out time holding section (1) 123, and sets timer section 124 for the time-out time to start timer section 124. When timer section 124 notifies the expiration of the set time, communication control section 12 forcefully starts communicating with downloading server 50 even when the communication starting restriction signal is still active and the start of communications is still suspended.

By thus providing the suspending time for starting communications with an upper limit, it is possible to avoid a situation that acquiring update data is not started for a long time.

Further, the time-out time for suspending the start of communications can be switched corresponding to type of trigger information.

In this case, trigger server 80 may prepare three types of identifiers of trigger information, and as illustrated in FIG. 18, switch the identifiers corresponding to urgency of trigger information for instructing an access.

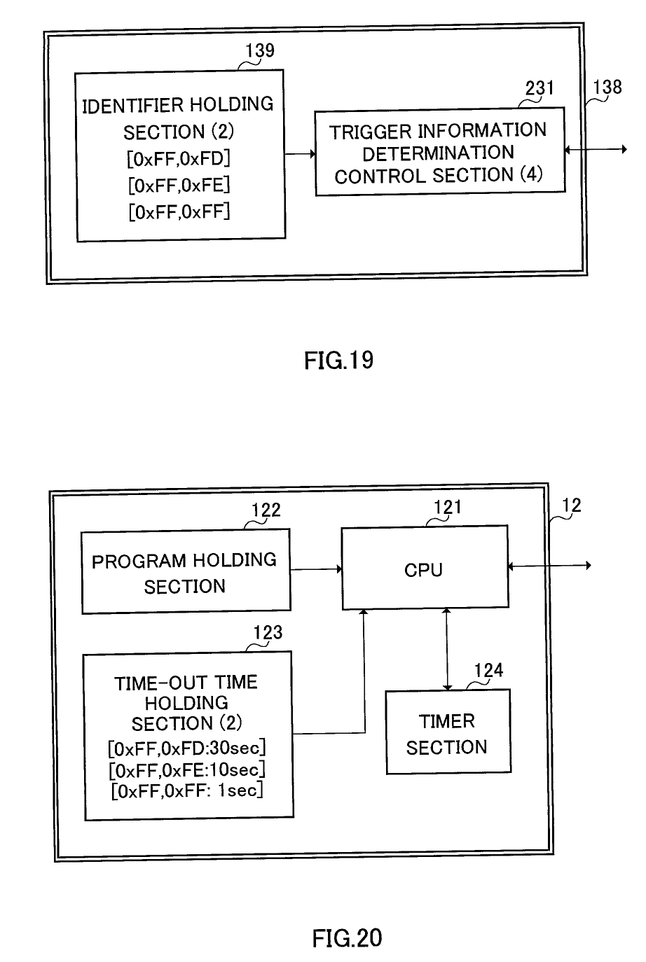

Meanwhile in data acquiring apparatus 10, as illustrated in FIG. 19, trigger information detecting section 138 in communication starting trigger section 13 holds three types of trigger information identifiers, i.e., ([0xFF,0xFD], [0xFF,0xFE] and [0xFF,0xFF]), in identifier holding section 2 (139), and as illustrated in FIG. 20, communication control section 12 holds information of time-out time ([0xFF,0xFD:30sec], [0xFF,0xFE:10sec] and [0xFF,0xFF:1sec]) respectively corresponding to the trigger information identifiers in time-out time holding section (2) 123.

When the received data contains one of the three types of trigger information identifiers, communication starting trigger section 13 of this apparatus identifies the received data as the trigger information, and outputs a communication starting notification with the trigger identifier contained therein to communication control section 12. At the time of receiving the notification from communication starting trigger section 13, when the communication starting restriction signal is active, communication control section 12 acquires the time-out time corresponding to the trigger identifier from time-out time holding section 123, and sets timer section 124 for the time-out time to start timer section 124. When timer section 124 notifies the expiration of the set time, communication control section 12 forcefully starts communicating with downloading server 50 even when the start of communications is still suspended.

In this way, data acquiring apparatus 10 is capable of acquiring the update date with high urgency even when non-PC apparatus 1 is operating, while with respect to update data with low urgency, acquiring the data after waiting for non-PC apparatus 1 to finish its operation or waiting for a sufficiently long time when non-PC apparatus 2 does not finish its operation.

(Fifth Embodiment)

Data acquiring apparatus of the fifth embodiment is capable of acquiring update data from a recording medium.

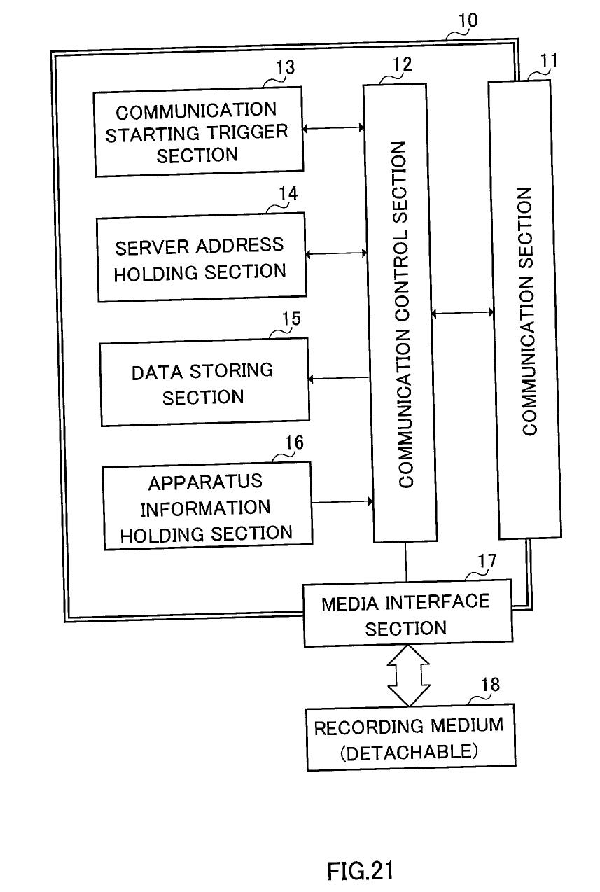

As illustrated in FIG. 21, the apparatus of this embodiment is provided with media interface section 17 to be mounted with a detachable recording medium 18. The configuration is the same as in the first embodiment (FIG. 2) except the foregoing.

Electronic data of the update data is stored in recording medium 18, and when recording medium 18 is mounted on media interface section 17, communication control section 12 reads the data stored in recording medium 18 via media interface section 17 to store in data storing section 15.

Thus, by having a route for acquiring update data from recording medium 18, it is possible to update the software of non-PC apparatus 1 even when data acquisition from the networks fails.

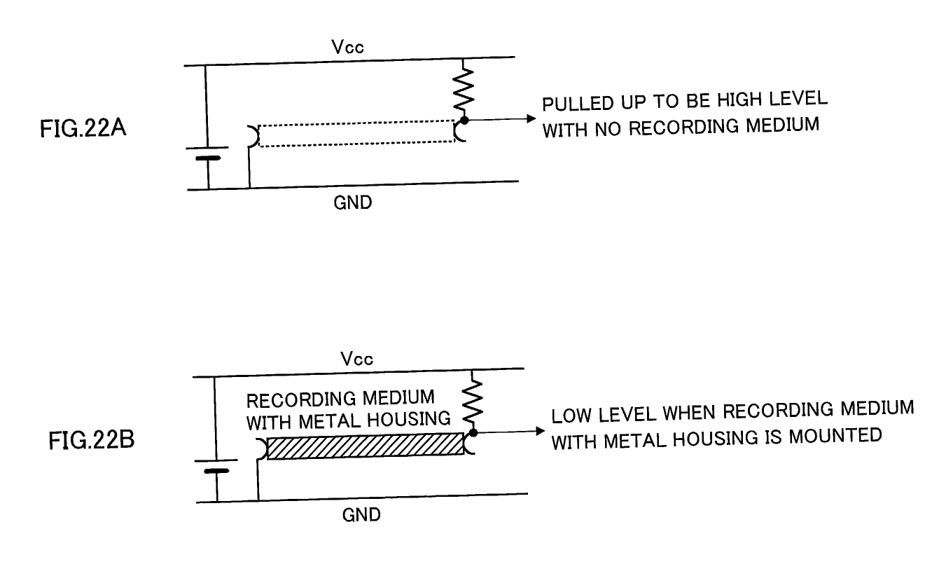

FIG. 22 illustrates an example of a mechanism for detecting recording medium 18 in media interface section 17. When recording medium 18 is not mounted (a), a detection voltage at an end of the resistance is of a high level. When recording medium 18 with a metal housing is mounted (b), since the resistance is connected to GND, the detection voltage falls to a low level. When the detection voltage is of the low level, communication control section 12 starts acquiring the electronic data from recording medium 18.

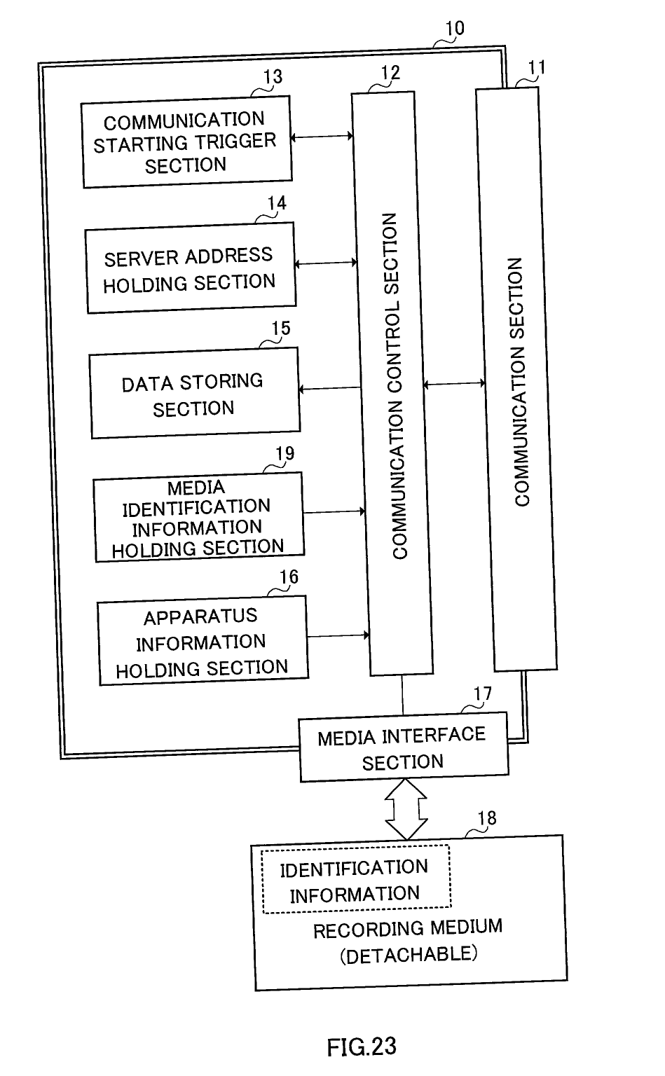

Further as illustrated in FIG. 23, it may be possible to store identification information in recording medium 18 and to provide data acquiring apparatus 10 with media identification information holding section 19, where communication control section 12 compares the identification information in recording medium 18 mounted on media interface section 17 with the electronic data held in media identification information holding section 19, and only when both data is coincident with each other, the electronic data is acquired from recording medium 18. In this case, it may be also possible that the identification information is encrypted and stored in recording medium 18, and that communication control section 12 decodes the encrypted identification information using a decoding key held in media identification information holding section 19, and then compares the decoded data with the electronic data held in media identification information holding section 19.

By thus storing the identification information in recording medium 18 and performing comparing procedures, it is possible to prevent data from being downloaded from recording medium 18 whose source is unknown and which may cause a malfunction.

(Sixth Embodiment)

The sixth embodiment explains a configuration where data acquiring apparatus 10 installs data acquired from downloading server 50 therein, and executes a recovery when necessary.

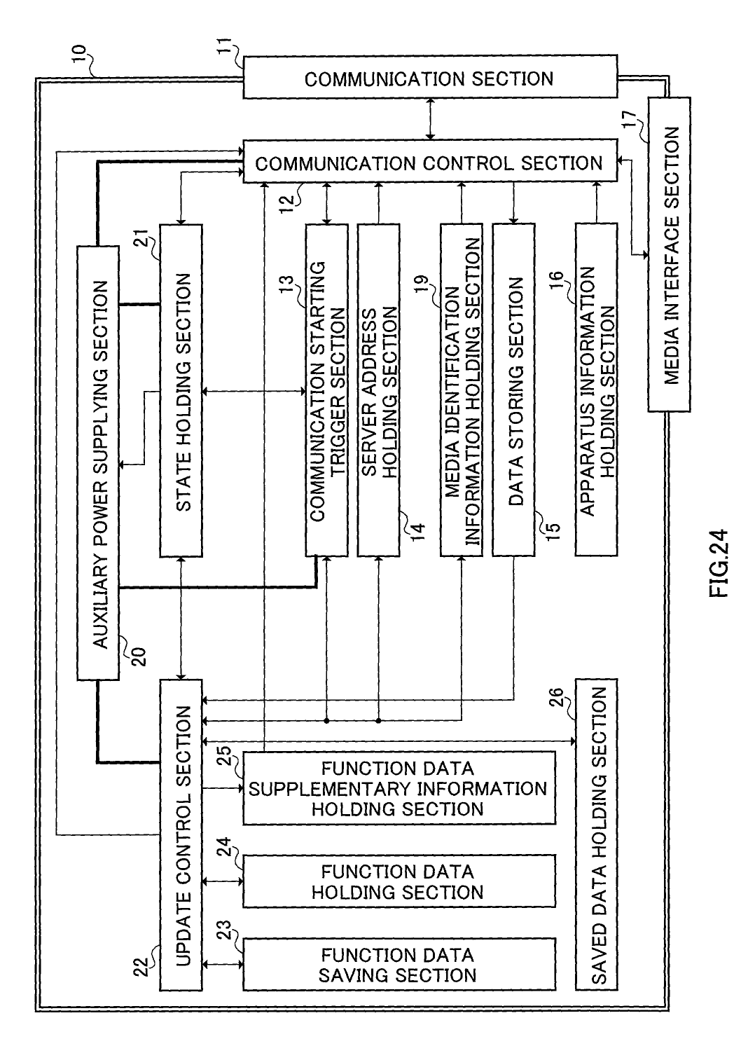

As illustrated in FIG. 24, this data acquiring apparatus 10 is provided with function data holding section 24 that holds function data comprised of a program for achieving the original function of non-PC apparatus 1 and various parameters, function data supplementary information holding section 25 that holds supplementary information, such as a time stamp and version number, of the electronic data held in function data holding section 24, update control section 22 that updates function data holding section 24 using the electronic data in data storing section 15 only when the data in the section 15 is newer than the electronic data in the section 24, state holding section 21, comprised of a non-volatile memory, which holds state information written from communication starting trigger section 13, communication control section 12 and update control section 22, auxiliary power supplying section 20 that assures the power supply during a period of time the data is written in state holding section 21, function data saving section 23 that stores the information to be updated stored in function data holding section 24, and saved data holding section 26 that stores information to be updated stored in server address holding section 14, communication starting trigger section 13, media identification information holding section 19 and communication control section 12. The configuration is the same as in the fifth embodiment (FIG. 23) except the foregoing.

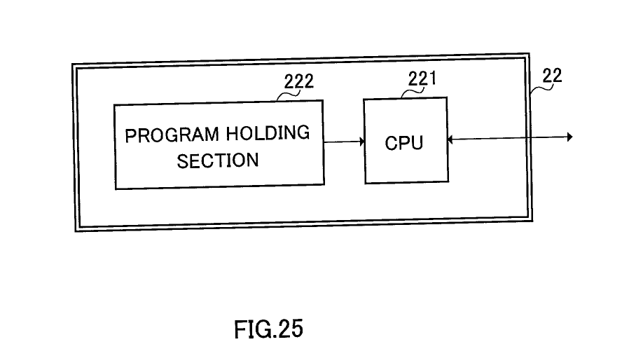

As illustrated in FIG. 25, update control section 22 is provided with CPU 221 and program holding section 222 that holds a program for specifying CPU 221.

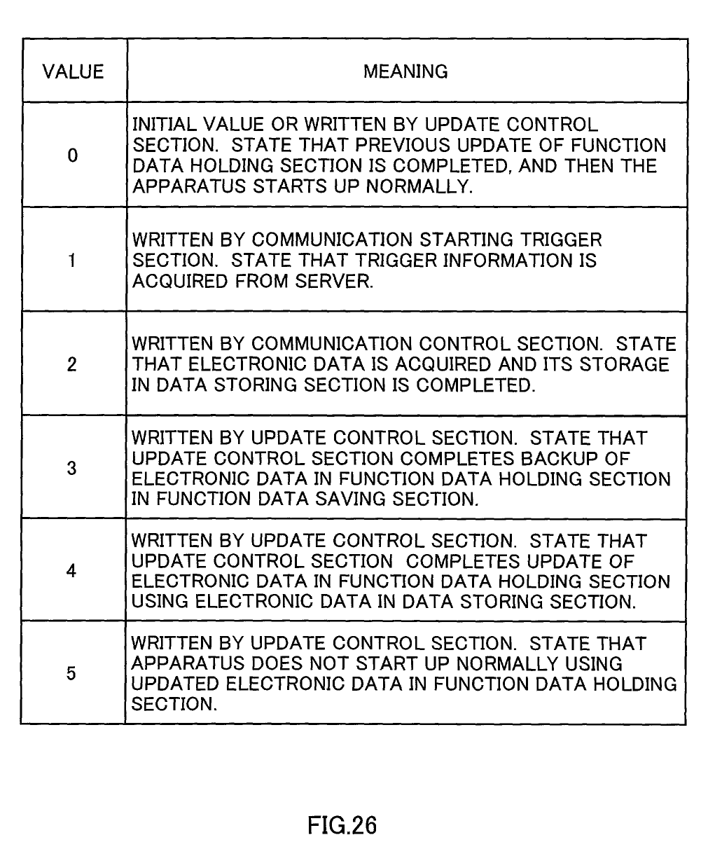

A value, as illustrated in FIG. 26, indicative of a progress of the processing in this apparatus is written in state holding section 21 from communication starting trigger section 13, communication control section 12 and update control section 22. State holding section 21 continues to hold the value even when power fails or a main supply is shut down. Therefore, after power or main supply is restored, it is possible to identify the progress of the processing from the value held in state holding section 21, and to continue the execution of the processing.

In order to keep holding the value, state holding section 21 is comprised of a non-volatile memory. Further, in order to perform the write assuredly even when the power supply to a main supply is suspended during the time the value is written in state holding section 21, auxiliary power is supplied to state holding section 21, and communication starting trigger section 13, communication control section 12 and update control section 22 which write the value in the section 21.

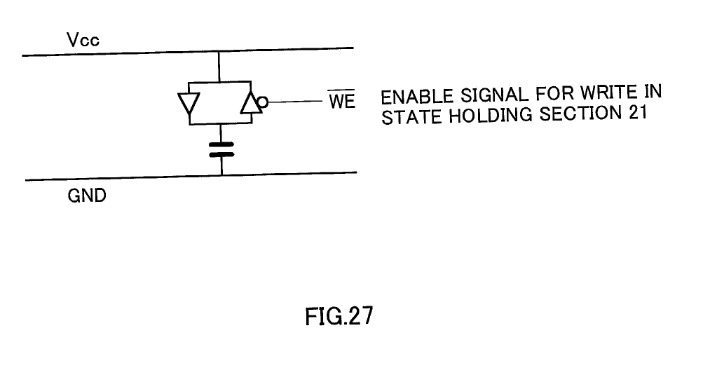

As an example of auxiliary power supplying section 20, FIG. 27 illustrates a circuit obtained by combining a capacitor and three-state buffer, where even when main supply voltage Vcc is shut down, the power stored in the capacitor is discharged and thereby Vcc is maintained during a period of time the enable signal for write in state holding section 21 is active.

The progress of the processing in the apparatus of this embodiment will be described below.

When function data holding section 24 is updated and then non-PC apparatus 1 starts up normally, update control section 22 writes “0” in state holding section 20.

When the trigger information is acquired from trigger server 80, communication starting trigger section 13 writes “1” in state holding section 20.

When the electronic data acquired from downloading server 50 is stored in data storing section 15, communication control section 21 writes “2” in state holding section 20.

In addition, as described later, when downloading server 50 notifies supplemental information such as a version and registration date/time of update data before transferring the update data, communication control section 12 compares the supplemental information notified from downloading server 50 with the supplemental information (supplemental information of function data held in function data holding section 24) held in function data supplemental information holding section 25, and only when the electronic data to be acquired from downloading server 50 is newer than the electronic data held in function data holding section 24, acquires the electronic data.

Update control section 22 saves as backup the data held in function data holding section 24 in function data saving section 23 comprised of a non-volatile memory. When the backup is completed, update control section 22 writes “3” in state holding section 20.

Using the data stored in data storing section 15, update control section 22 next updates the data in function data holding section 24. After completing the update, update control section 22 writes “4” in state holding section 20.

When the start-up of non-PC apparatus 1 is normally completed using the updated data in function data holding section 24, update control section 22 writes “0” in state holding section 20 and finishes the install procedures. Further, when the start-up of non-PC apparatus 1 is not completed normally, the section 22 writes “5” in state holding section 20.

When update control section 22 writes “5” in state holding section 20, the section 22 keeps a log of errors, and transmits the log of errors to downloading server 50 after restoring the data stored in function data saving section 23 to function data holding section 24 and restarting non-PC apparatus 1.

Further, when the power is supplied, update control section 22 examines a value held in state holding section 21. When the value is not 0, corresponding to the value, the section 22 instructs communication control section 12 to resume the processing suspended when the power was last shut down, or resumes the processing suspended when the power was last shut down.

Furthermore, as described later, when downloading server 50 or trigger server 80 transmits information such as a server address change notification, read request time, read request interval, time-out time and identifier, using pertinent data stored in data storing section 15, update control section 22 updates the data stored in server address holding section 14, communication starting trigger section 13, media identification information holding section 19 and communication control section 12. At this point, saved data holding section 26 may store the data to be updated so that the data held in saved data holding section 26 is restored when the data update fails.

Also in the above case, writing each state of the update processing in state holding section 20 enables the processing to be recovered after power fails or the main supply is shut down.

The data acquiring apparatus of this embodiment thus installs and recovers the data acquired from the downloading server.

(Seventh Embodiment)

The seventh embodiment explains a configuration of downloading server 50.

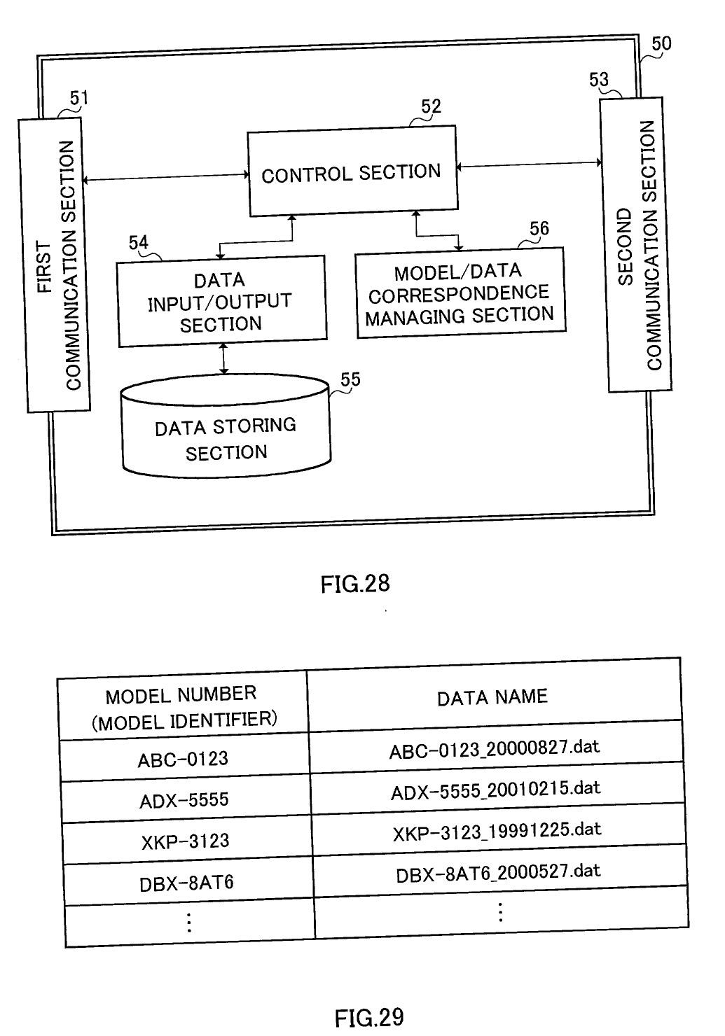

As illustrated in FIG. 28, downloading server 50 is provided with first communication section (FCS) 51 that is connected to first network 2 to communicate data therewith, second communication section (SCS) 53 that is connected to second network 3 to communicate data therewith, data storing section (DSS) 55 that stores write data transferred via second network 3, data input/output section (D-I/O-S) 54 that writes data with a write request in data storing section (DSS) 55, while reading data requested to read from data storing section (DSS) 55, model/data correspondence managing section (M/D-CMS) 56 that brings a data name of data stored in data storing section (DSS) 55 into correspondence with model information of the non-PC apparatus to manage, and control section 52 that controls data write and read.

As illustrated in FIG. 29, model/data correspondence managing section (M/D-CMS) 56 defines the correspondence between a data name (data identifier) stored in data storing section (DSS) 55 and a model number (model identifier), and describes the correspondence in a table to manage.

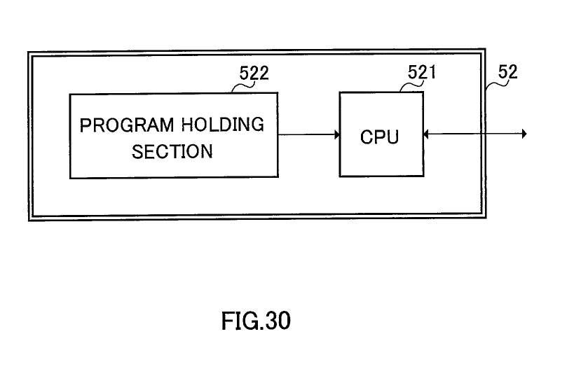

As illustrated in FIG. 30, control section 52 is provided with CPU 521 and program holding section 522 that holds a program for specifying the operation of CPU 521.

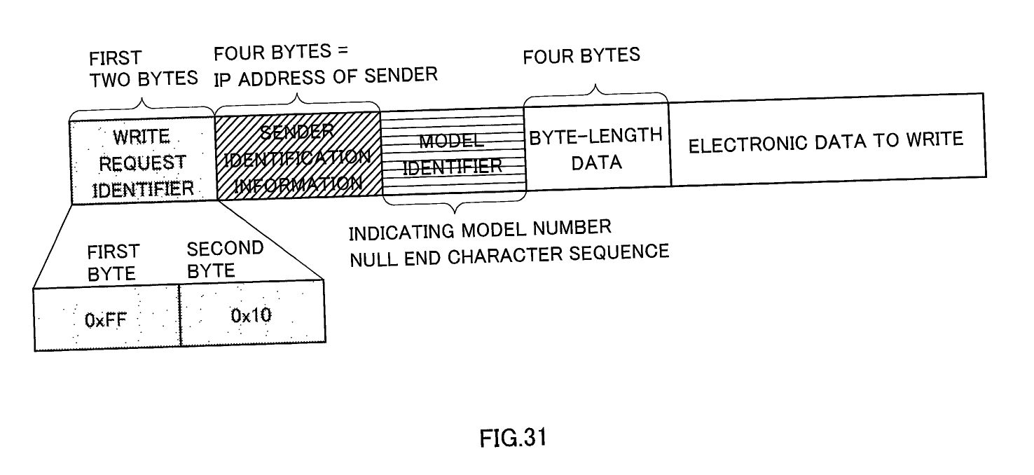

As illustrated in FIG. 31, the write request data input via second communication section (SCS) 53 is composed of a write request identifier indicative of a write request, sender identification information (IP address) indicative of a sender, model identifier indicative of a model number with which the data associates, byte length of electronic data, and the electronic data to be written. In addition, when second network 3 is of telephone channel, an IP address that is the sender identification information is not necessary.

When control section 52 in downloading server 50 receives the write request communication data via second communication section (SCS) 53, the section 52 extracts the model identifier and electronic data, and obtains data identifier corresponding to the model identifier from model/data correspondence managing section (M/D-CMS) 56. Model/data correspondence managing section (M/D-CMS) 56 provides the data identifier corresponding to the model to control section 52, and describes the relationship therebetween in the table to manage. Control section 52 requests data input/output section (D-I/O-S) 54 to write the electronic data corresponding to the data identifier in data storing section (DSS) 55. When data input/output section (D-I/O-S) 54 receives the data identifier and electronic data, the section 54 writes the electronic data in data storing section (DSS) 55.

Meanwhile, as described previously, data acquiring apparatus 10 transmits the read request communication data as illustrated in FIG. 6 to downloading server 50 via first network 2. When control section 52 in downloading server 50 receives the read request communication data via first communication section (FCS) 51, the section 52 extracts a model identifier and sender identification information, and obtains a data identifier corresponding to the model identifier from model/data correspondence managing section (M/D-CMS) 56. Model/data correspondence managing section (M/D-CMS) 56 reads the data identifier corresponding to the model identifier from the table to provide to control section 52, and control section 52 notifies data input/output section (D-I/O-S) 54 of the data identifier to request the section 54 to read the data from data storing section (DSS) 55. When data input/output section (D-I/O-S) 54 reads the corresponding electronic data, control section 52 transmits the electronic data to the IP address of the sender identification information.

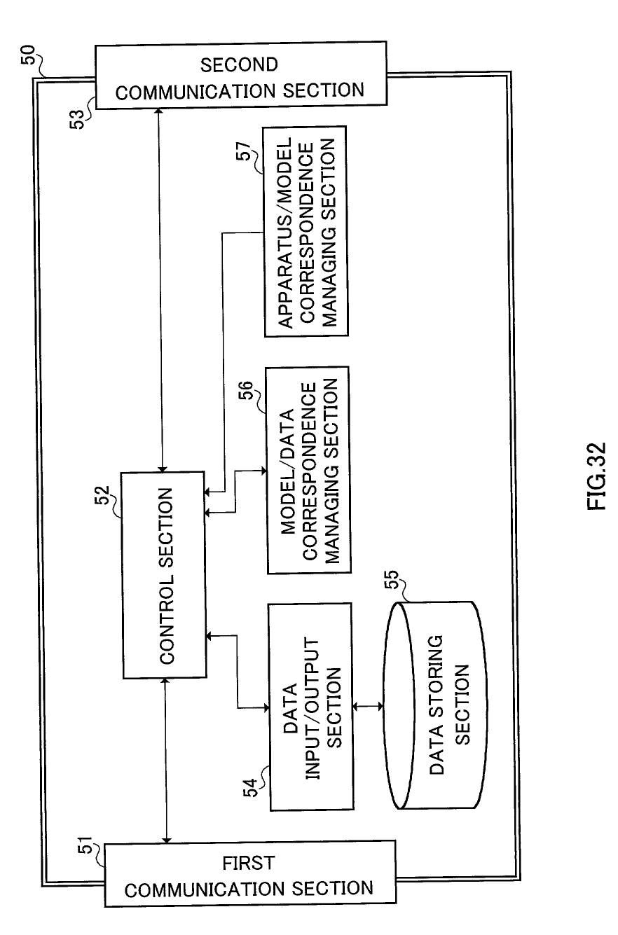

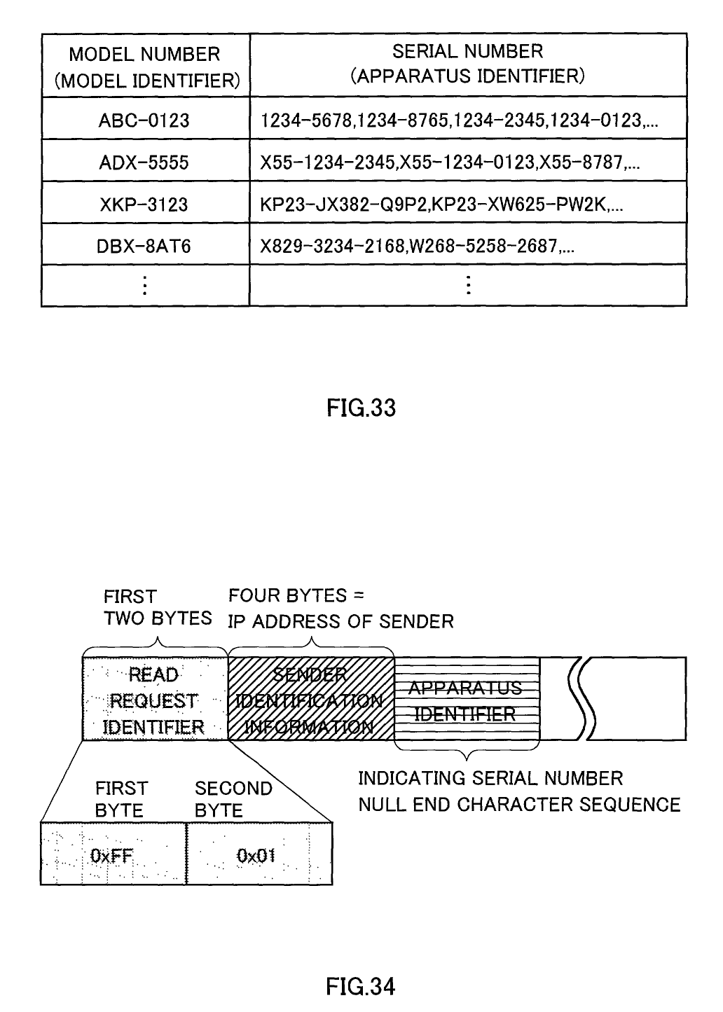

Further, as illustrated in FIG. 32, downloading server 50 may have apparatus/model correspondence managing section (A/M-CMS) 57 that manages the correspondence between an apparatus identifier (serial number) that individually identifies the apparatus and model identifier (model number). As illustrated in FIG. 33, apparatus/model correspondence managing section (A/M-CMS) 57 brings the model number into correspondence with the serial number of each apparatus having the model number to manage.

In this case, as illustrated in FIG. 34, data acquiring apparatus 10 is capable of transmitting to downloading server 50 read request communication data containing the apparatus identifier (which is held in apparatus information holding section 16 in data acquiring apparatus 10). When control section 52 in downloading server 50 receives this read request communication data via first communication section (FCS) 51, the section 52 extracts the apparatus identifier and sender identification information, acquires a model corresponding to the apparatus identifier from apparatus/model correspondence managing section (A/M-CMS) 57, and further acquires a data identifier corresponding to the mode from model/data correspondence managing section (M/D-CMS) 56. The processing thereafter is the same as in FIG. 28.

Further, when the write request communication data received via second communication section (SCS) 53 contains a model identifier and apparatus identifier, control section 52 in downloading server 50 extracts the model identifier and apparatus identifier, and brings the apparatus identifier into correspondence with the model identifier to register with apparatus/model correspondence managing section (A/M-CMS) 57.

Thus, when downloading server 50 receives a request for update data with the model identifier and/or apparatus identifier indicated therein from data acquiring apparatus 10 and stores the data in data storing section (DSS) 55, the server 50 is capable of transferring the data to data acquiring apparatus 10.

(Eighth Embodiment)

The eighth embodiment explains a system having a plurality of downloading servers.

When the downloading server exists only in a single place, since data acquiring requests from all the data acquiring apparatuses are concentrated on the downloading server, the traffic increases and the smooth processing is disturbed. Therefore, in this system, downloading servers having the same data are located in different areas so as to decentralize the data acquiring request.

A configuration for a plurality of downloading servers to hold the same data will be described first.

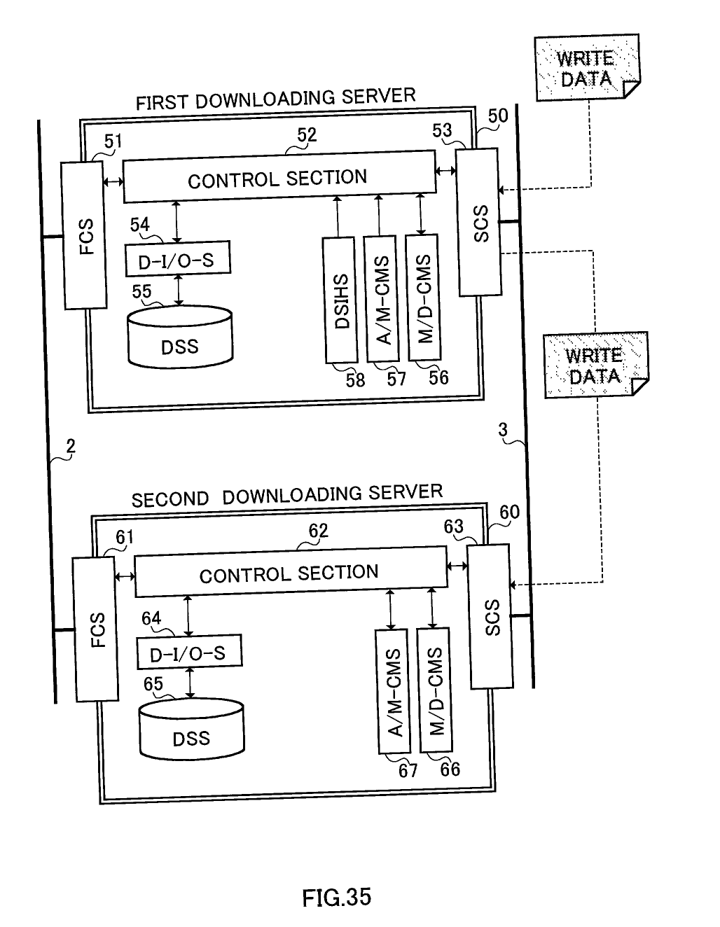

As illustrated in FIG. 35, in this system, first downloading server 50 is connected to second downloading server 60 via second network 3. A configuration of second downloading server 60 is the same as the configuration in FIG. 32 in the seventh embodiment, and a configuration of downloading server 50 is also the same as that in FIG. 32 except that the server 50 further has downloading server identifier holding section (DSIHS) 58 that holds an address of second downloading server 60 on network 3.

When control section 52 in first downloading server 50 receives the write request communication data via second communication section (SCS) 53, the section 52 stores the data in data storing section (DSS) 55, and then transmits the write request communication data via second network 3 to second downloading server 60 of the address held in downloading server identifier holding section (DSIHS) 58. Control section 62 in second downloading server 60 receives the write data, and stores the data in data storing section (DSS) 65.

Thus, first downloading server 50 transfers the write request communication data to downloading servers at different areas, or a downloading server that receives the write request communication data transfers the write request communication data to another downloading server sequentially, and thereby all the downloading servers are capable of holding the same write data in respective data storing sections.

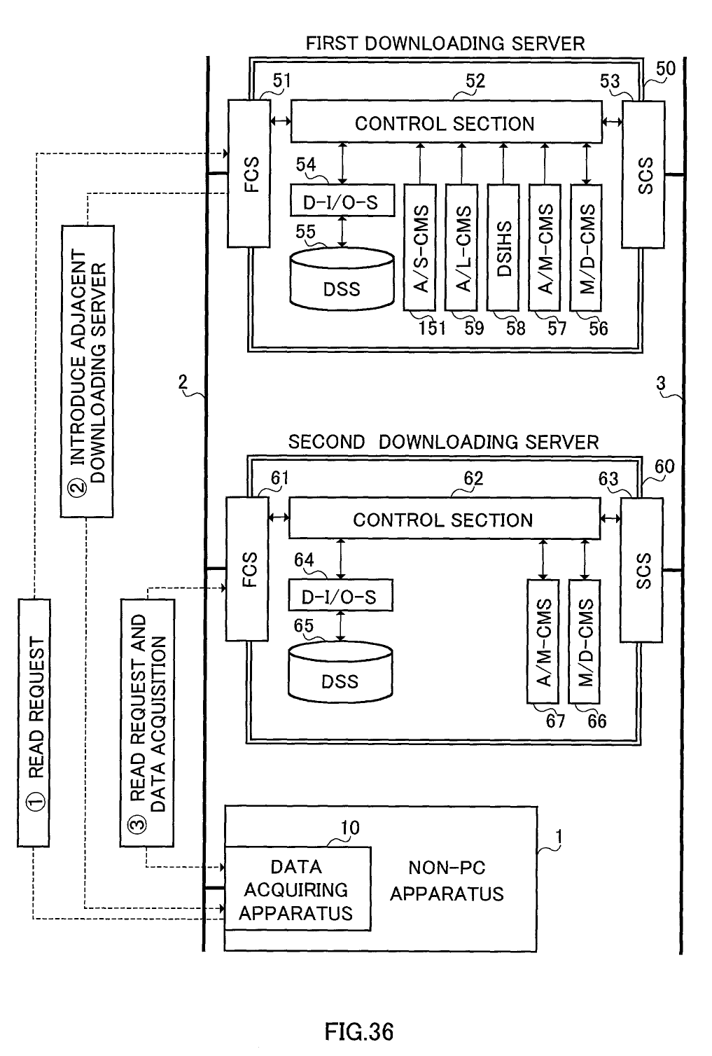

FIG. 36 illustrates a system where a plurality of downloading servers 50 and 60 holding the same write data in respective data storing sections are located. First downloading server 50 is provided with apparatus/location correspondence managing section (A/L-CMS) 59 that manages the correspondence between the apparatus identifier and location of the apparatus, and area/server correspondence managing section 151 (A/S-CMS) that manages the correspondence between an area such that a downloading server provides services and an address to identify the downloading server over network 2, in addition to the configuration in FIG. 35.

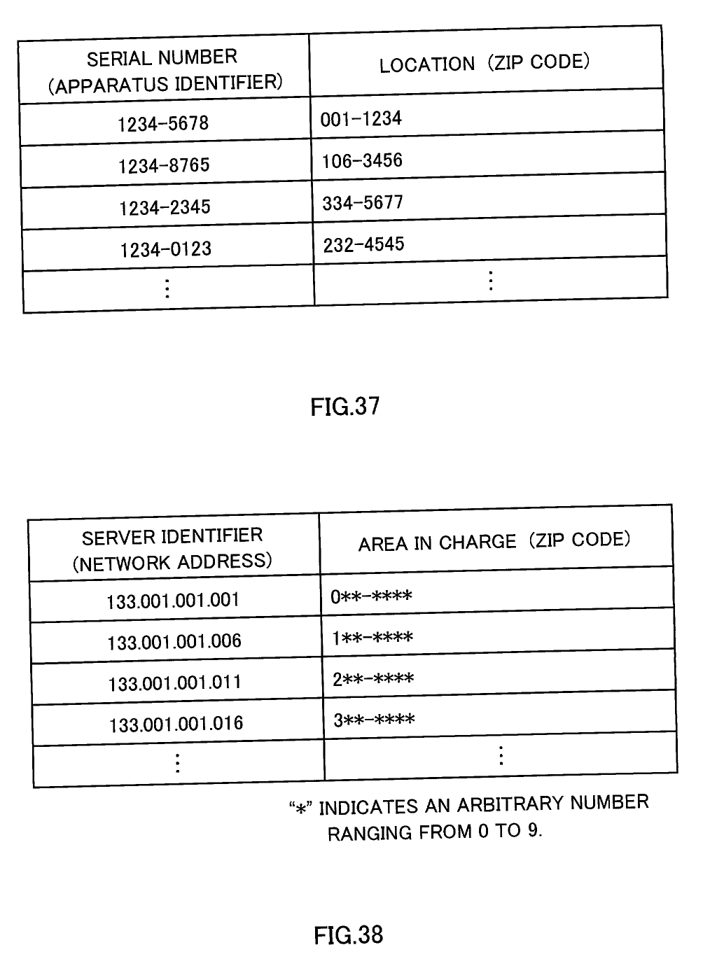

As illustrated in FIG. 37, apparatus/location correspondence managing section (A/L-CMS) 59 manages the correspondence relationship between a serial number and a ZIP code of an area in which the apparatus exists. The data is generated from data of user registration of a user that purchased the apparatus. Further, as illustrated in FIG. 38, area/server correspondence managing section (A/S-CMS) 151 manages the correspondence relationship between a server identifier (network address) and an area in charge thereof specified by a first-digit number of the ZIP code.

Data acquiring apparatus 10 first transmits the read request communication data (FIG. 34) containing a serial number (apparatus identifier) to first downloading server 50 to request for downloading of the update data. Control section 52 in first downloading server 50 acquires a ZIP code corresponding to the serial number contained in the read request from apparatus/location correspondence managing section (A/L-CMS) 59, further acquires a network address of a server taking charge of an area of the ZIP code from area/server correspondence managing section (A/S-CMS) 151, and notifies the network address to data acquiring apparatus 10.

When data acquiring apparatus 10 receives the information, update control section 22 updates a server address held in server address holding section 14. As a result, data acquiring section 10 transmits the read request communication data to second downloading server 60 introduced from first downloading server 50 next time and thereafter.

It is thus made possible in this system that read requests from data acquiring apparatuses 10 are decentralized and a plurality of downloading servers cope with the requests.

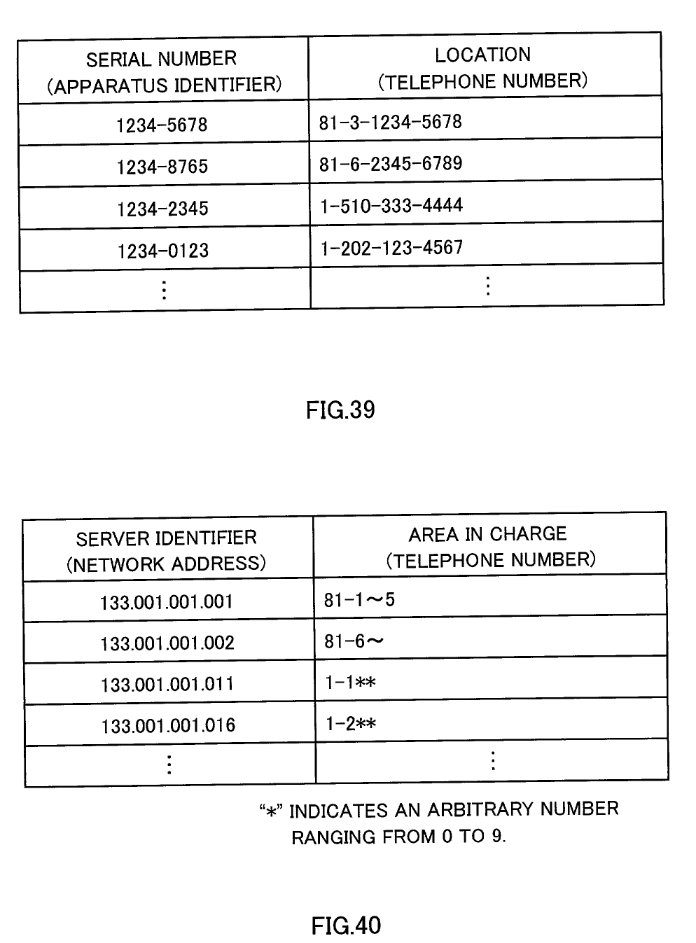

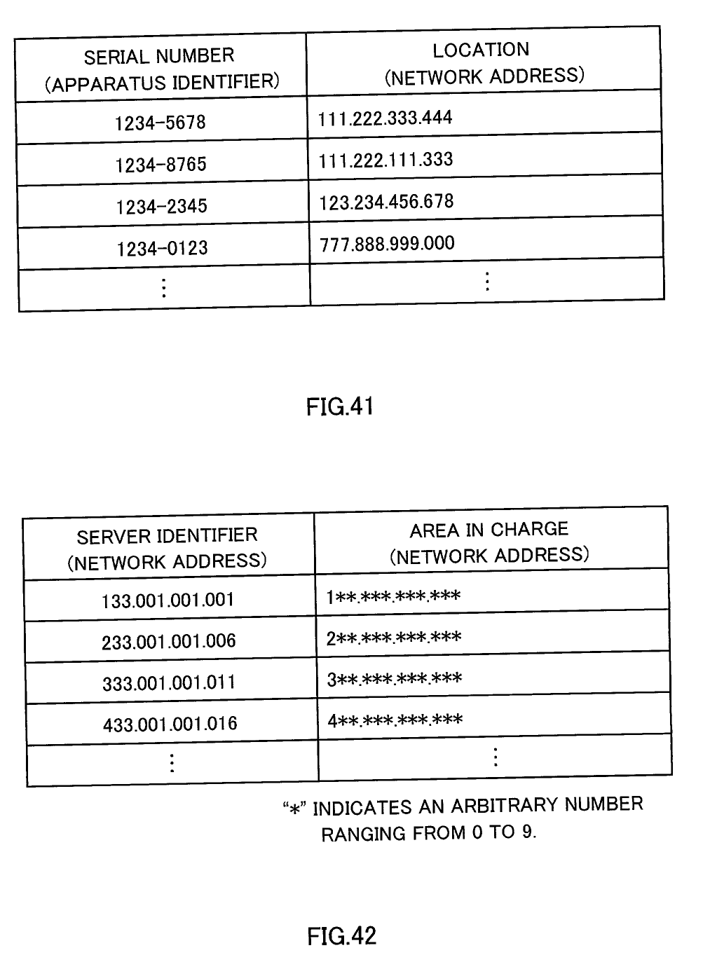

In addition, as illustrated in FIG. 39, apparatus/location correspondence managing section (A/L-CMS) 59 may manage the correspondence relationship between a serial number and telephone number of a user based on data of user registration, while as illustrated in FIG. 40, location/server correspondence managing section (A/S-CMS) 151 may manage the correspondence relationship between a server identifier (network address) and area in charge thereof specified by the telephone number (county code and first-digit number of an area code). Further, as illustrated in FIG. 41, apparatus/location correspondence managing section (A/L-CMS) 59 manages the correspondence relationship between a serial number and network address of a user based on the data of user registration, while as illustrated in FIG. 42, area/server correspondence managing section (A/S-CMS) 151 manages the correspondence relationship between a server identifier (network address) and area in charge thereof specified by the network address.

(Ninth Embodiment)

A downloading server of the ninth embodiment provides various information to the data acquiring apparatus so as to enable the data acquiring apparatus to acquire update data smoothly.

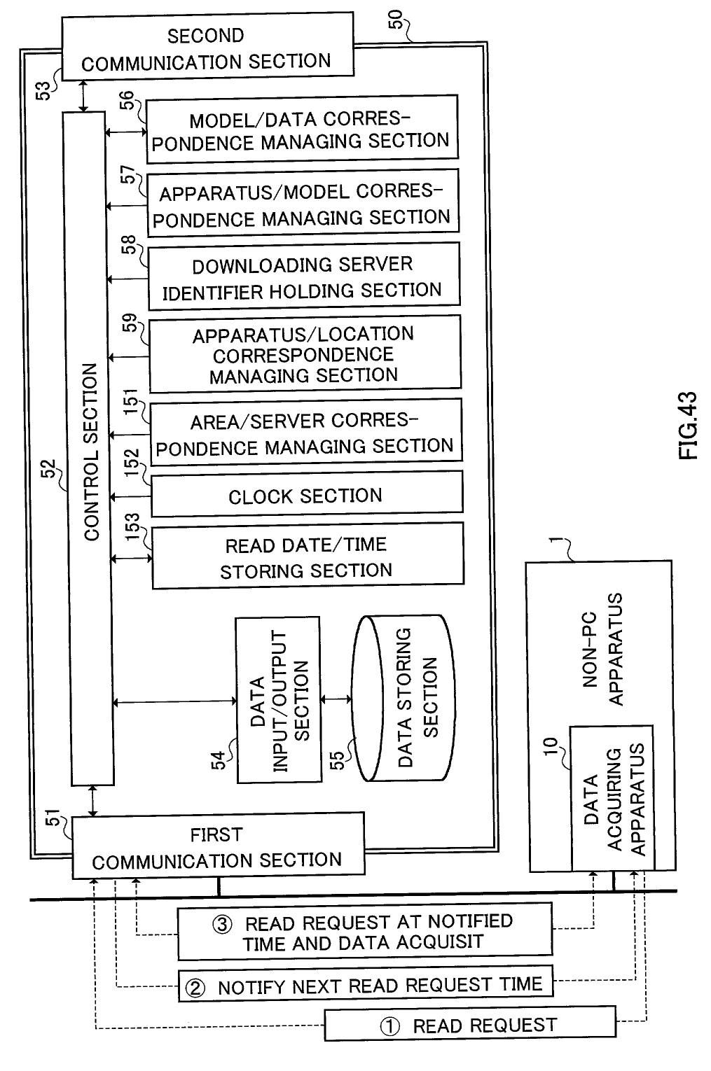

Downloading server 50 illustrated in FIG. 43 notifies data acquiring apparatus 10 of a next read request time. Downloading server 50 of this embodiment is provided with clock section (CS) 152 that records the time and outputs information of a current date and time, and read date/time storing section (R-D/T-SS) 153 that stores information of a date and time at which the read request communication data arrived at first communication section (FCS) 51. The configuration is the same as that of first downloading server 50 in the eighth embodiment (FIG. 36) except the foregoing.

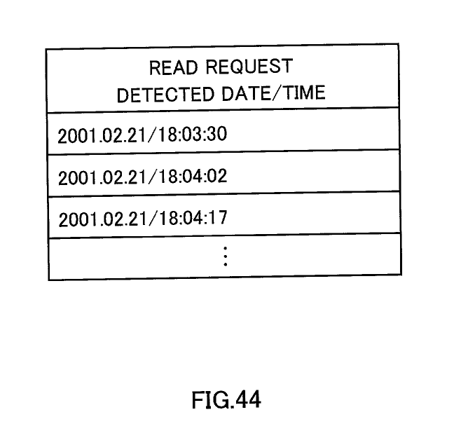

FIG. 44 indicates data of read request detected date and time held in read date/time storing section (R-D/T-SS) 153.

When detecting an arrival of read request communication data at first communication section (FCS) 51, control section 52 in server 50 acquires date/time information from clock section (CS) 152 to write in read data/time storing section (R-D/T-SS) 153. Further, control section 52 divides a day into predetermined time intervals, calculates the number of read requests during each time interval based on data stored in read date/time storing section (R-D/T-SS) 153, and obtains a time period with the least read requests. Then, when receiving a read request from data acquiring apparatus 10, control section 52 notifies, as a next read request time, a time during the time period with the least read requests to an address of the sender identification information contained in the read request communication data via first communication section (FCS) 51.

In data acquiring apparatus 10 having received the information, update control section 22 updates a time held in server connection time holding section 132 in communication starting trigger section 13 to the time notified from downloading server 50. As a result, data acquiring apparatus 10 is capable of transmitting next time and thereafter read request communication data at the time relatively less data is communicated notified from downloading server 50.

In addition, clock section (CS) 152 may output information of a day of the week in addition to the date and time, read date/time storing section (R-D/T-SS) 153 may store information of date, time and day of the week on which the read request communication data arrived, and control section 52 may designate next read request date, time and day of the week, using the information stored in read date/time storing section (R-D/T-SS) 153.

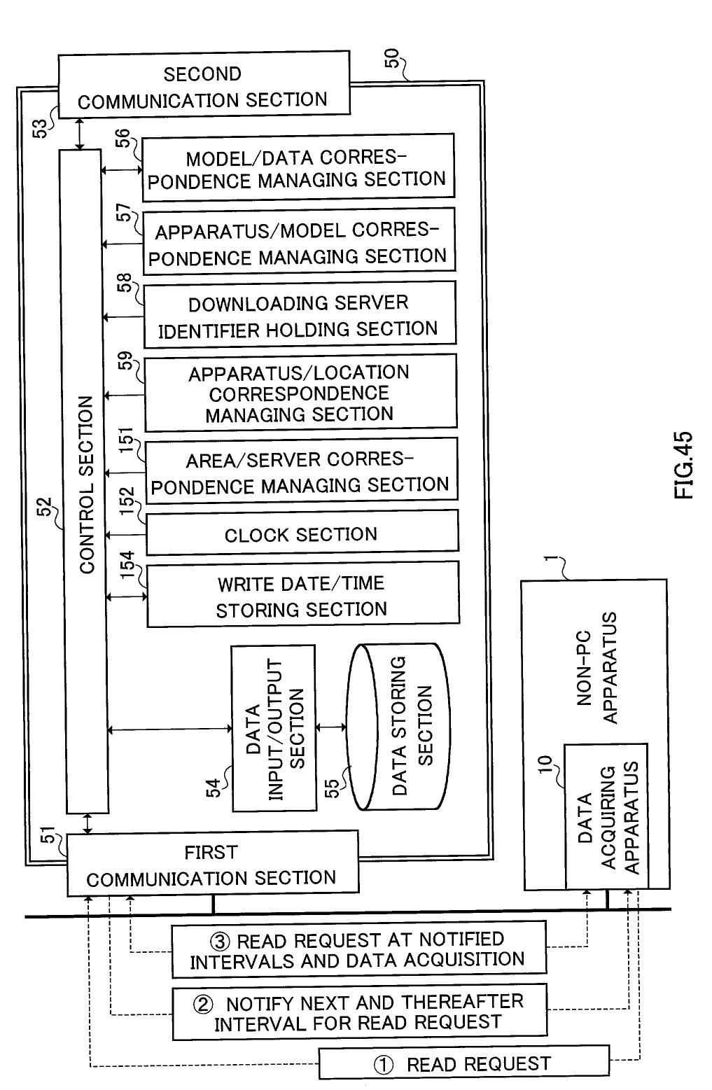

Based on a data write cycle, downloading server 50 illustrated in FIG. 45 notifies data acquiring apparatus 10 of a time interval for making a read request next time and thereafter. This downloading server 50 is provided with clock section (CS) 152 that records the time and outputs information of a current date and time, and write date/time storing section 154 that stores a date and time of arrival of write request communication data. The configuration is the same as that of first downloading server 50 in the eighth embodiment (FIG. 36) except the foregoing.

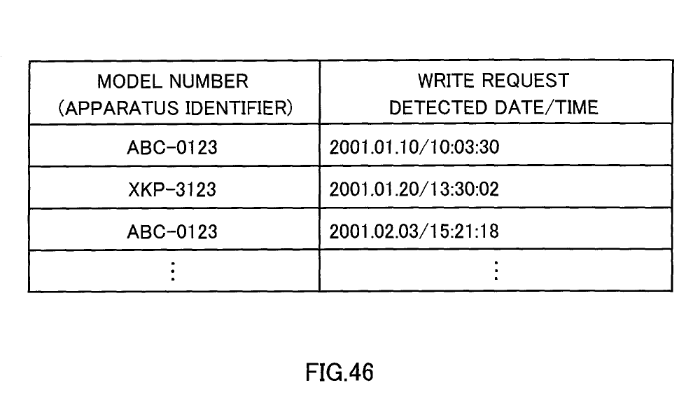

As illustrated in FIG. 46, write date/time storing section 154 holds data of write request detected date and time in correspondence with a model number (apparatus identifier).

When detecting an arrival of write request communication data at second communication section (SCS) 53, control section 52 in server 50 acquires date/time information from clock section (CS) 152, brings the date/time information into correspondence with information of the model number contained in the write request communication data, and stores the date/time information in write data/time storing section 154. Further, when control section 52 detects an arrival of the read request communication data at first communication section (FCS) 51, the section 52 calculates a write time interval of write data corresponding to the model targeted for the read request from data stored in write date/time storing section 154, and notifies the interval to an address of the sender identification information contained in the read request communication data via first communication section (FCS) 51.

In data acquiring apparatus 10 having received the information, update control section 22 rewrites a connection time interval held in server connection interval holding section 136 in communication starting trigger section 13 to the time interval notified from downloading server 50, and transmits read request communication data at intervals notified from downloading server 50 next time and thereafter. Therefore, data acquiring apparatus 10 is capable of making a read request in accordance with an update cycle of write data, and thereby of decreasing situations such that the apparatus 10 transmits read request communication data, but the data is not updated, and the request goes to waste.

Further also in this case, clock section (CS) 152 may output information of a day of the week in addition to the date and time, write date/time storing section 154 may store information of date, time and day of the week, and control section 52 may designate a read request cycle with a day of the week.

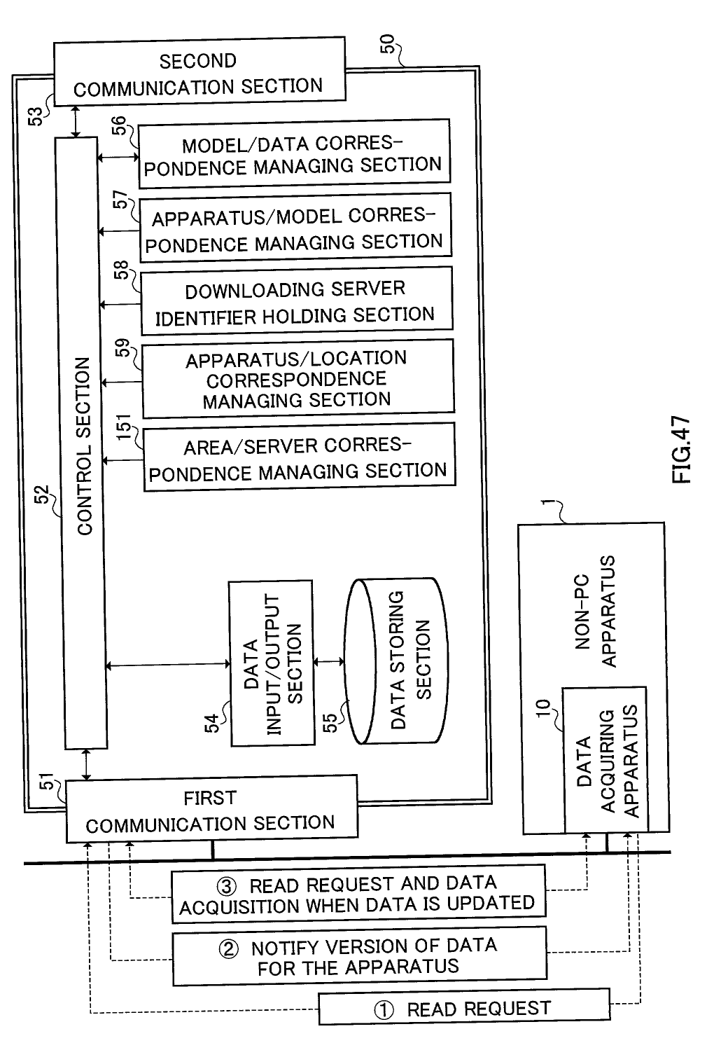

Downloading server 50 illustrated in FIG. 47 notifies data acquiring apparatus 10, which has made a data read request, of information of a version of write data stored in data storing section (DSS) 55. When the version of write data is newer than the version of data that the apparatus 10 holds, data acquiring apparatus 10 requests for read of the data. The configuration of this server 50 is the same as that of first downloading server 50 in the eighth embodiment (FIG. 36).

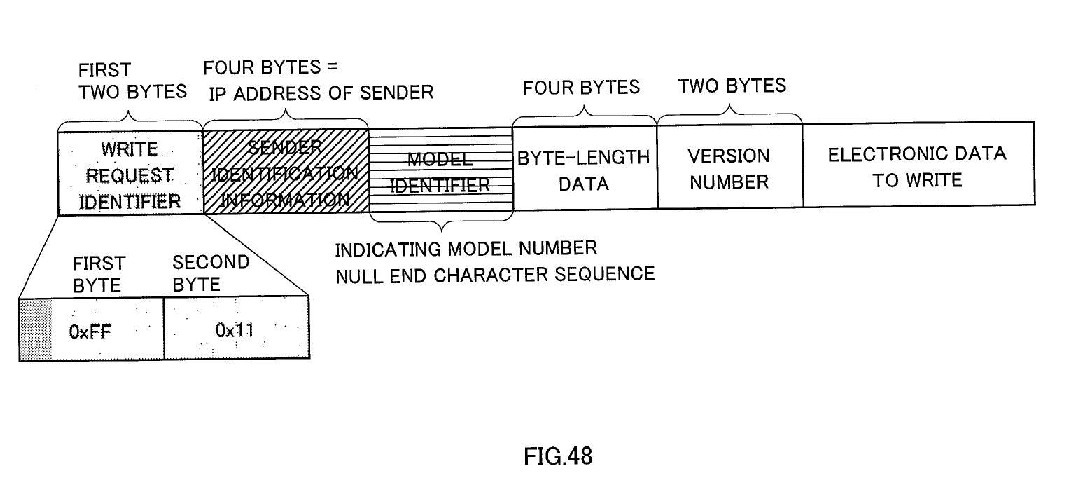

In this case, as illustrated in FIG. 48, the write request communication data transmitted from downloading server 50 contains information of a version number of electronic data targeted for write. When control section 52 in downloading server 50 detects an arrival of write request communication data at second communication section (SCS) 53, the section 52 extracts version information of electronic data targeted for write from the request communication data and writes the information in data storing section (DSS) 55 with the electronic data.

Further, when control section 52 detects an arrival of read request communication data at first communication section (FCS) 51, the section 52 first acquires version information of electronic data to be sent back from data storing section (DSS) 55 to transmit to an address of the sender identification information via first communication section (FCS) 51.

In data acquiring apparatus 10 having received the information, update control section 22 compares a number of a version held in function data supplemental information holding section 25 with the received version number, and when the received version number is a newer one, requests for read of the data again. When the received version number is not the newer one, the section 22 cancels the read request.

When receiving the read request again, control section 52 in downloading server 50 transmits the electronic data to be sent back to data acquiring apparatus 10 via first communication section (FCS) 51.

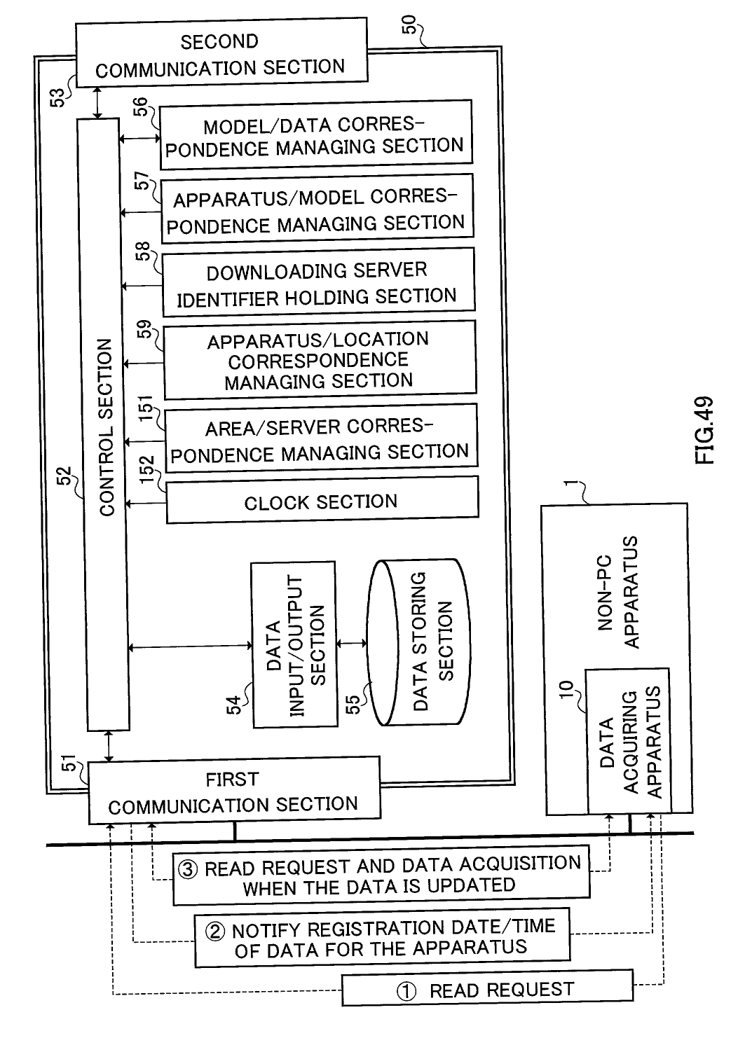

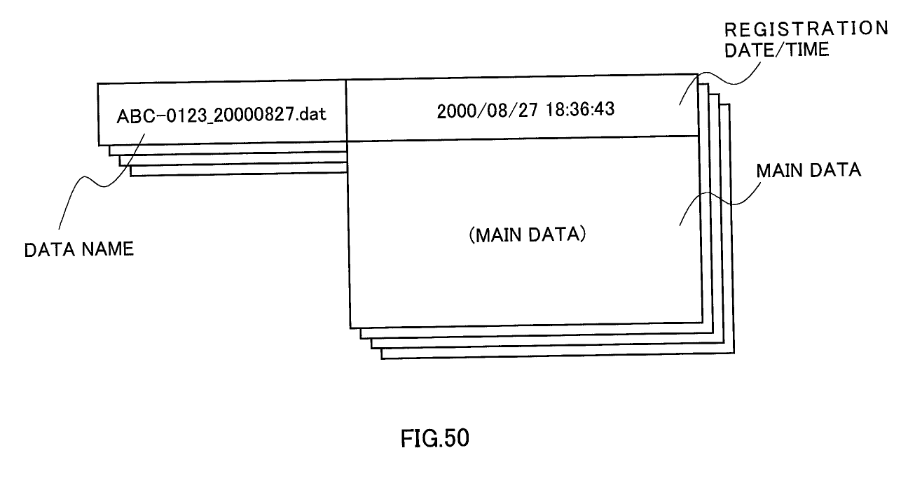

Downloading server 50 illustrated in FIG. 49 is provided with clock section (CS) 152. At the time of writing the electronic data in data storing section (DSS) 55, control section 52 in the server 50 acquires information of year, date and time of this point from clock section (CS) 152, and stores the information in data storing section 55 (DSS) with the electronic data. FIG. 50 illustrates schematic data held in data storing section (DSS) 55. The data has a registration date and time in addition to a data name and main data.

When detecting an arrival of read request data at first communication section 52, control section 52 in downloading server 50 first acquires information of registration date and time of the electronic data to be sent back from data storing section (DSS) 55, and transmits the data to an address of the sender identification information via first communication section (FCS) 51.

In data acquiring apparatus having received the information, update control section 22 compares the information of registration date and time of last acquired data held in function data supplemental information holding section 25 with the received registration date and time, and when the received registration date and time is a newer one, requests for read of the data again. When the received registration date and time is not the newer one, the section 22 cancels the read request.

When receiving the read request again, control section 52 in downloading server 50 transmits the electronic data to be sent back to data acquiring apparatus 10 via first communication section (FCS) 51.

Thus, downloading server 50 notifies data acquiring apparatus 10 of a version number and/or registration data and time of update data, and data acquiring apparatus 10 confirms the necessity of data update, whereby it is possible to prevent unnecessary update data from being downloaded.

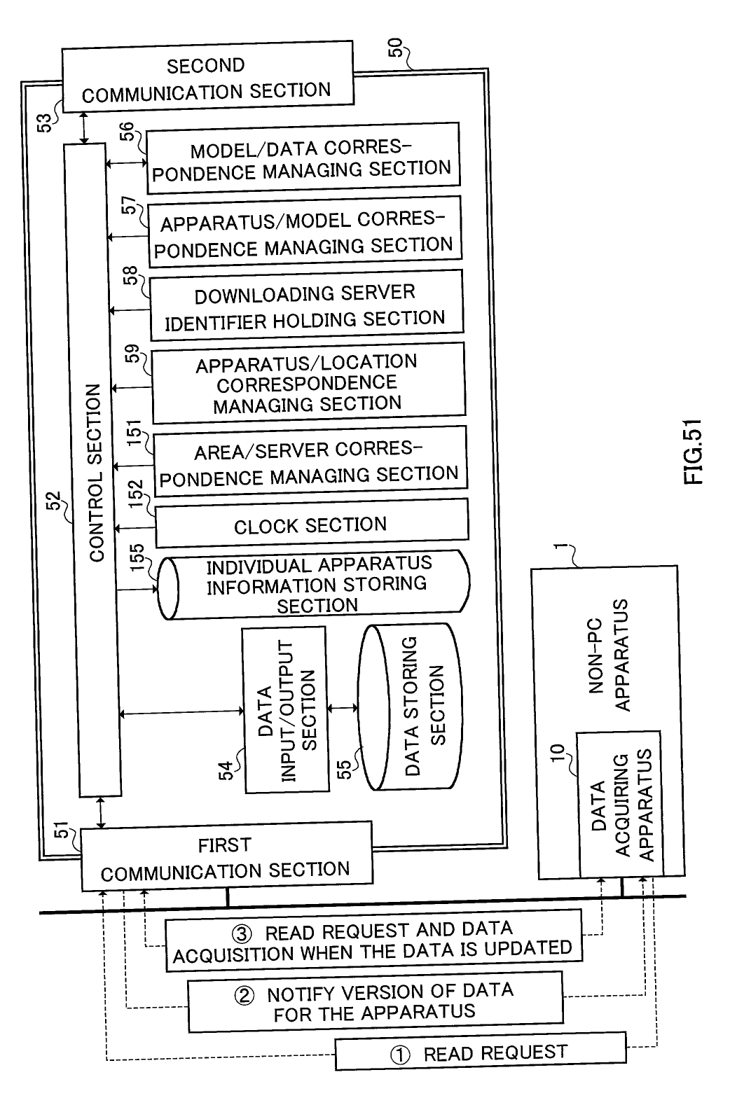

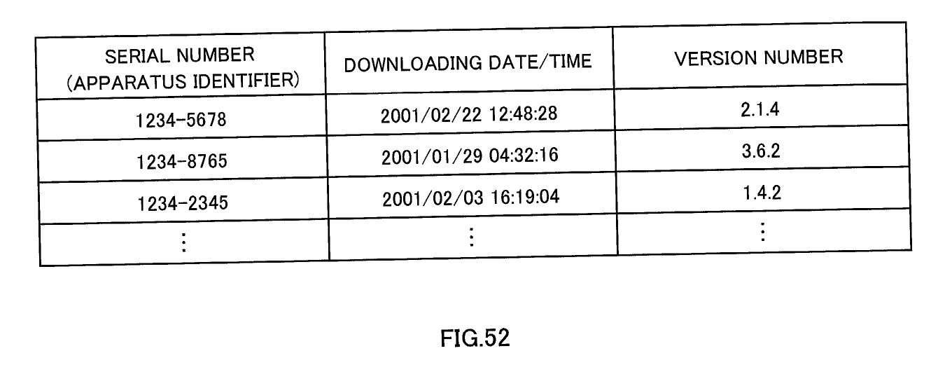

Downloading server 50 illustrated in FIG. 51 is provided with individual apparatus information storing section 155 that holds history data of update data acquisition in each data acquiring apparatus 10. As illustrated in FIG. 52, in individual apparatus information storing section 155 are stored a downloading date/time and version number in correspondence with a serial number (apparatus identifier). At the time of transmitting electronic data corresponding to read request communication data received via first communication section (FCS) 51, control section 52 in downloading server 50 writes the version number of the electronic data and date/time obtained from clock section (CS) 152 in individual apparatus information storing section 155 with the serial number (apparatus identifier) contained in the read request communication data. Using the record stored in individual apparatus information storing section 155, for example, when a bug is found in the electronic data, it is possible to promptly examine destinations to which the electronic data was transferred.

(Tenth Embodiment)

The tenth embodiment explains a basic configuration of the trigger server.

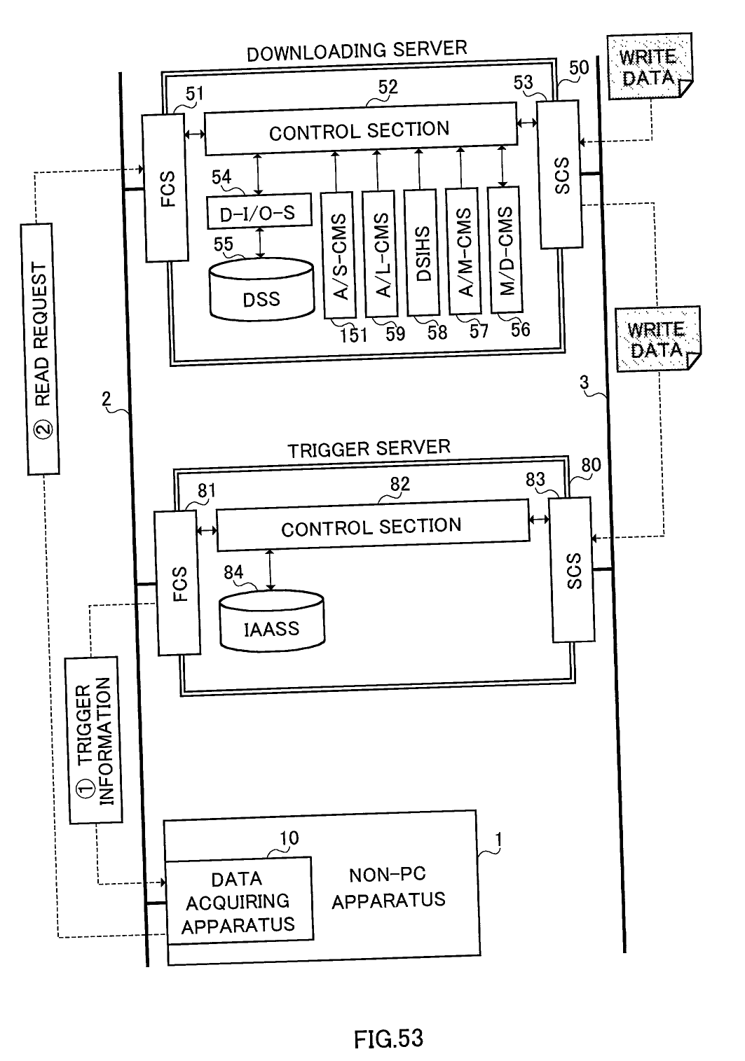

FIG. 53 illustrates a system comprised of downloading server 50, trigger server 80 and data acquiring apparatus 10.

Trigger server 80 is provided with first communication section (FCS) 81 connected to first network 2, second communication section (SCS) 83 connected to second network 3, individual apparatus address storing section (IAASS) 84 that stores an address of each non-PC apparatus 1 on the network, and control section 82 that transmits trigger information for instructing data acquiring apparatus 10 in non-PC apparatus 1 to connect to downloading server 50.

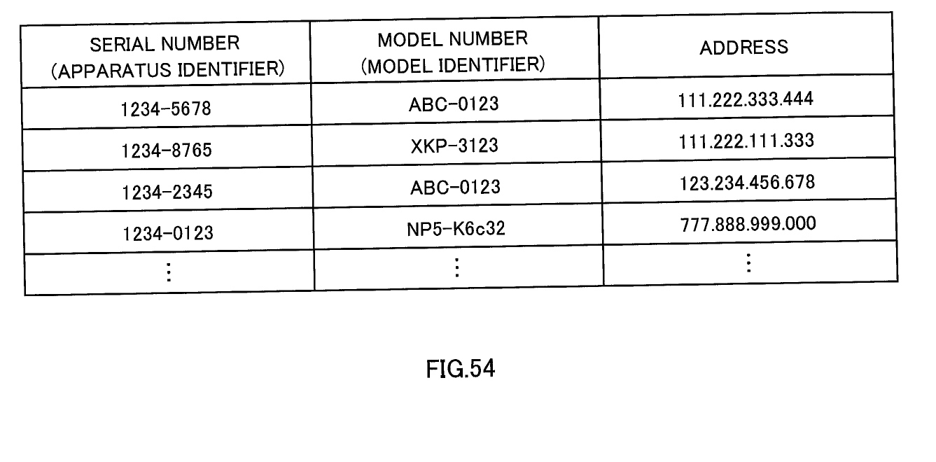

FIG. 54 illustrates data held in individual apparatus address storing section (IAASS) 84, where each serial number (apparatus identifier), model number (model identifier) and address are associated and stored. These items of data are collected from data of user registration of a user that purchased the non-PC apparatus, or the like.

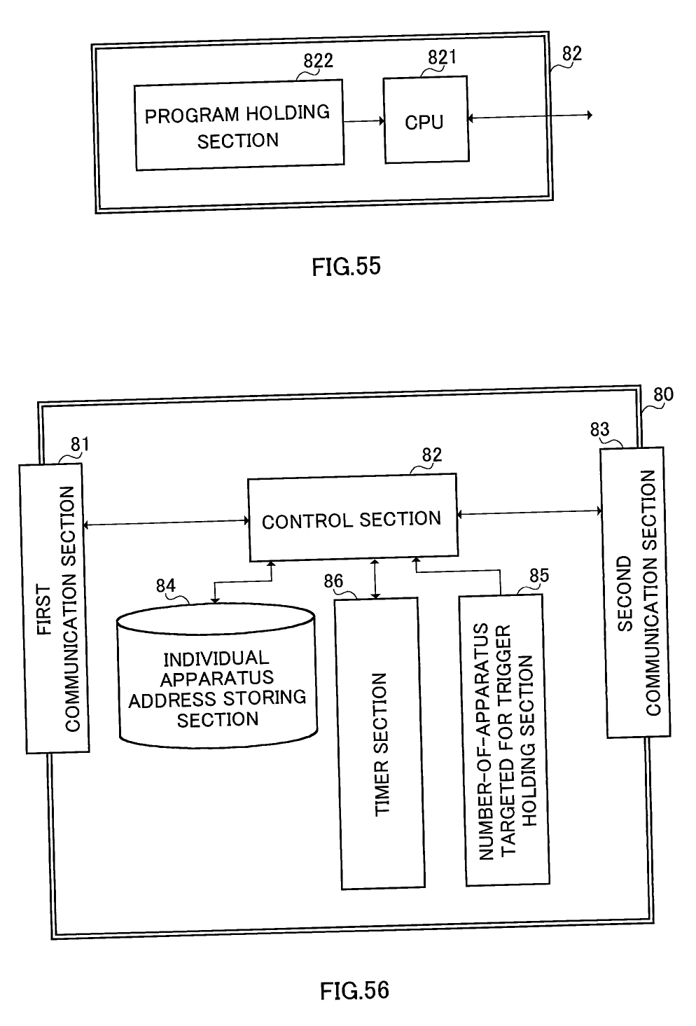

FIG. 55 illustrates a configuration of control section 82 in trigger server 80. The section 82 is provided with CPU 821 and program holding section 822 that stores a program for specifying the operation of CPU 821.

When downloading server 50 receives write request communication data in second communication section (SCS) 53 and stores the write request data in data storing section (DSS) 55, the server 50 transfers the write request communication data to trigger server 80.

When control section 82 in trigger server 80 receives the write request communication data via second communication section (SCS) 83, the section 82 extracts information of a model number (apparatus identifier) contained in the write request communication data. Then, the section 82 acquires an address of an apparatus corresponding to the model number from individual apparatus address storing section (IAASS) 84, and transmits the trigger information illustrated in FIG. 9 to the address.

As previously described, in data acquiring apparatus in 10 in non-PC apparatus 1 having received the information, trigger information detecting section 138 in communication starting trigger section 13 detects the trigger information to notify to communication control section 12, and communication control section 12 transmits read request communication data to downloading server 50 to acquire update data.

(Eleventh Embodiment)

A trigger server of the eleventh embodiment transmits trigger information to data acquiring apparatuses at respective different times in order for read requests from the data acquiring apparatuses not to concentrate on a certain period of time.

As illustrated in FIG. 56, the trigger server of this embodiment is provided with number-of-apparatus targeted for trigger holding section (NTTHS) 85 that holds the number of apparatuses to which trigger information is transmitted once, and timer section 86 that notifies the expiration of a time for which the section 86 is set.

When the number of apparatuses to which the trigger information is transmitted among apparatuses recorded in individual apparatus address storing section (IAASS) 84 exceeds the predetermined number held in number-of-apparatus targeted for trigger holding section (NTTHS) 85, control section 82 in trigger server 80 transmits the trigger information to the predetermined number of apparatuses, and then starts up time section 86 to wait for a lapse of time. When timer section 86 notifies the expiration of the set time, control section 82 transmits again the trigger information to the predetermined number of apparatus to which the trigger information is not transmitted, and then starts up timer section 86. Thus, the trigger server of this embodiment transmits trigger information to data acquiring apparatuses 10 of predetermined number held in number-of-apparatus targeted for trigger holding section (NTTHS) 85 at intervals, and thereby is capable of avoiding the concentration of read requests from data acquiring apparatuses.

Further in this case, at the time of extracting the predetermined number of apparatuses to which the trigger information is transmitted from individual apparatus address storing section (IAASS) 84, control section 82 selects the predetermined number of destinations at random from a list held in individual apparatus address storing section (IAASS) 84. In this way, even when the list has addresses according to predetermined rule (for example, for each area), it is possible to avoid the concentration of read requests on a particular downloading server.

(Twelfth Embodiment)

A trigger server of the twelfth embodiment checks whether a read request is made in response to the trigger information.

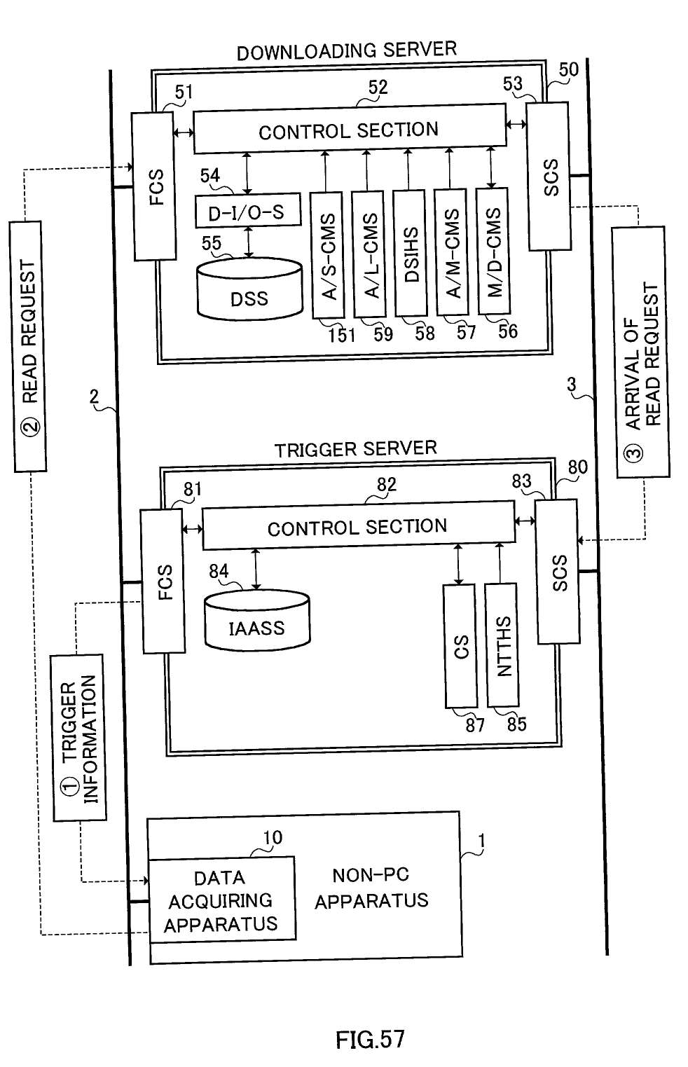

As illustrated in FIG. 57, the trigger server of this embodiment is provided with clock section 87 that records a current time.

At the time of transmitting the trigger information to data acquiring apparatus 10, control section 82 in trigger server 80 acquires information of year, date and time from clock section 87, and brings the information into correspondence with an apparatus identifier of a corresponding apparatus in the list of individual apparatus address storing section (IAASS) 84 to write as trigger transmitted data/time information.

When control section 52 in downloading server 50 receives read request communication data from data acquiring apparatus 10, the section 52 transmits a read request detection signal including the serial number of the apparatus to trigger server 80 via second communication section (SCS) 53.

When control section 82 in trigger server 80 receives the read request detection signal from control section 52 in downloading server 50, the section 82 acquires the information of year, date and time from clock section 87, and brings the information into correspondence with an apparatus identifier of the apparatus in the list in individual apparatus address storing section (IAASS) 84 to write as read request data/time information.

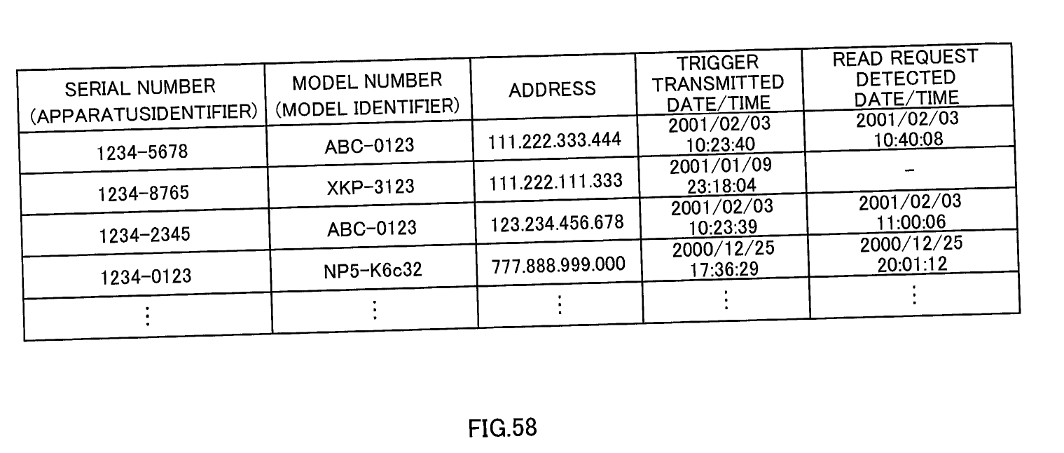

FIG. 58 illustrates data thus written in individual apparatus address storing section (IAASS) 84. From the data, it is possible to check for an apparatus (apparatus with read request detected data/time of “-”) to which the trigger information was transmitted, but which has not made a read request, and control section 82 retransmits the trigger information to such an apparatus when necessary.

(Thirteenth Embodiment)

A trigger server of the thirteenth embodiment preferentially transmits trigger information for instructing acquisition of update data with a higher priority.

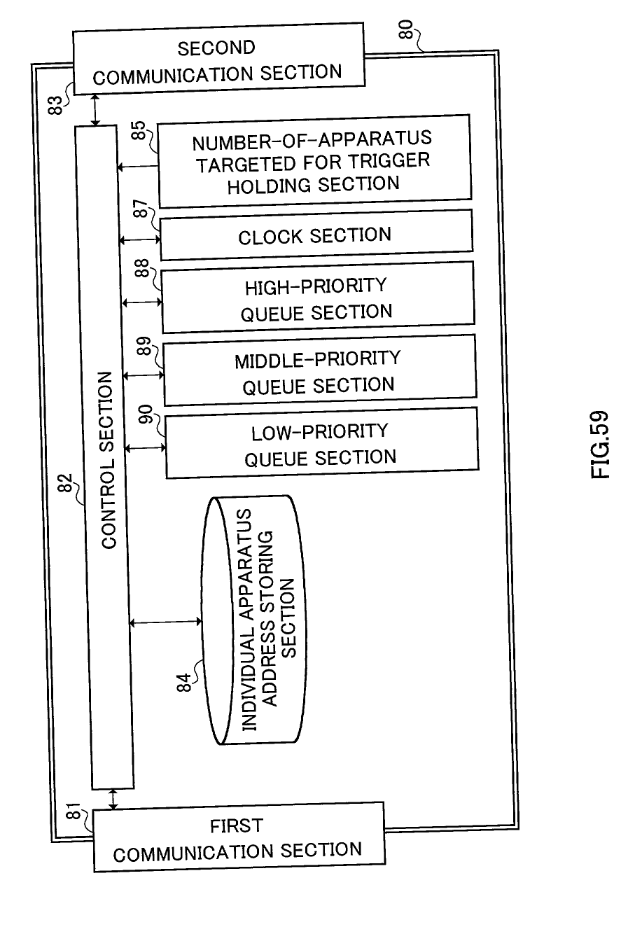

As illustrated in FIG. 59, the trigger server of this embodiment is provided with high-priority queue section 88 that holds a list of write data of high priority, middle-priority queue section 89 that holds a list of write data of middle priority, and low-priority queue section 90 that holds a list of write data of low priority.

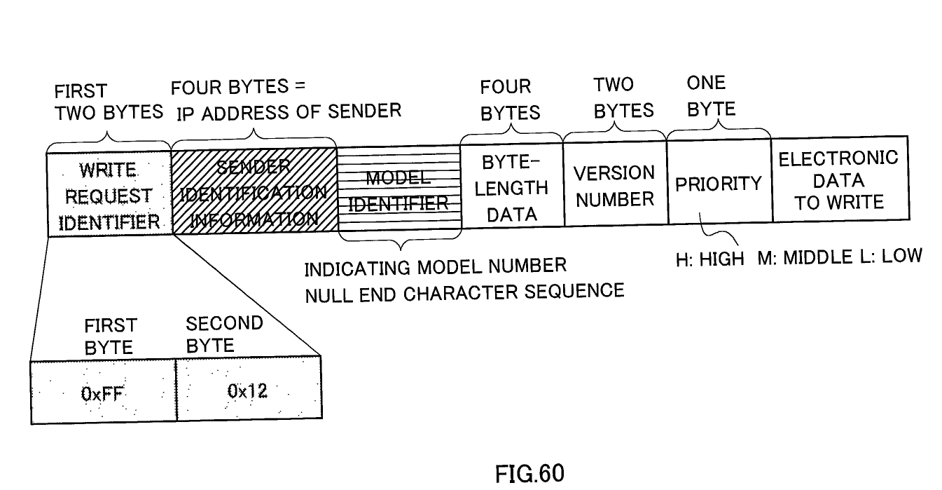

Further as illustrated in FIG. 60, the write request communication data transferred from downloading server 50 to trigger server 80 contains data indicative of a priority (high, middle or low) of electronic data targeted for the write.

Corresponding to the priority contained in the write request communication data transferred from downloading server 50, control section 82 in trigger server 80 allocates the processing for transmitting the trigger information for instructing to acquire respective write data to high-priority queue section 88, middle-priority queue section 89 and low-priority queue section 90 to register therewith.

Then, control section 82 first performs the processing for transmitting the trigger information registered with high-priority queue section 88. After finishing all the processing registered with high-priority queue section 88, the section 82 next performs the processing for transmitting the trigger information registered with middle-priority queue section 89. After finishing all the processing registered with middle-priority queue section 89, the section 82 next performs the processing for transmitting trigger information registered with low-priority queue section 90.

At this point, control section 82 uses, as a trigger information identifier of trigger information to transmit, different identifiers corresponding to the processing registered with high-priority queue section 88, middle-priority queue section 89 and low-priority queue section 90, respectively, as illustrated in FIG. 18. In this way, data acquiring apparatus 10 is capable of also identifying a priority of write data, and thereby of setting the time-out time corresponding to the priority of write data as previously described in FIG. 20.

By thus providing transmission of trigger information with time differences corresponding to priority of write data, the data acquiring apparatus is capable of rapidly downloading update data with high urgency and thereby with a high priority.

(Fourteenth Embodiment)

A trigger server of the fourteenth embodiment adds communication starting time information to the trigger information to transmit.

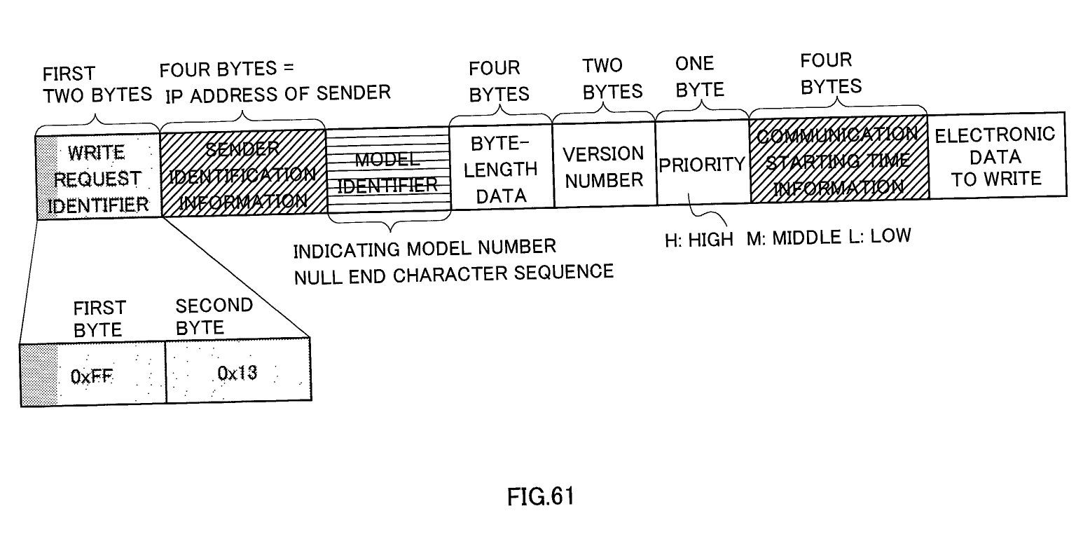

As illustrated in FIG. 61, the write request communication data enables itself to contain the communication starting time information for data acquiring apparatus 10 to start downloading write data from downloading server 50.

When the write request communication data transferred from downloading server 50 contains the communication starting time information, control section 82 in trigger server 80 extracts the communication starting time information, and adds the information to the trigger information to transmit as illustrated in FIG. 14. As described in FIG. 15 previously, data acquiring apparatus 10 having received the trigger information transmits read request communication data to downloading server 50 at the designated communication starting time.

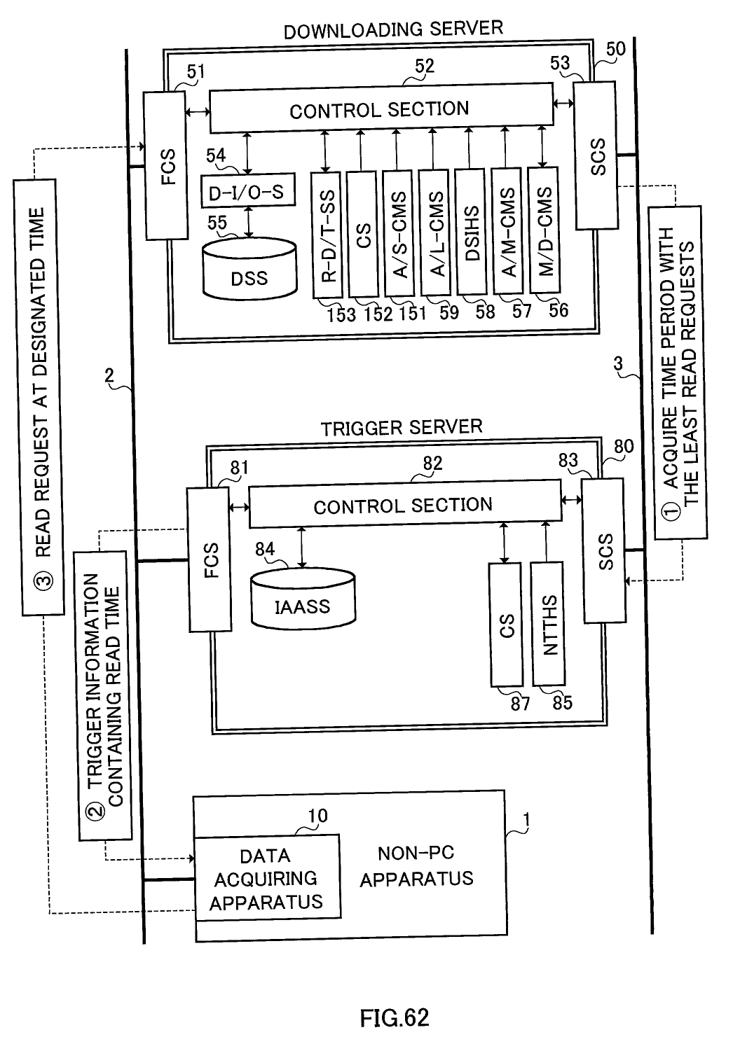

Further as illustrated in FIG. 62, when downloading server 50 is provided with clock section (CS) 152 and read date/time storing section (R-D/T-SS) 153 and calculates a time period with the least frequency of read requests as in the ninth embodiment (FIG. 43), it may be possible that control section 52 in downloading server 50 transmits the information of the calculated time period with the least frequency of read requests to trigger server 80, and that control section 82 in trigger server 80 adds the communication starting time set based on the information to the trigger information to transmit.

In addition, while the embodiments explain that downloading server 50 and trigger server 80 are different apparatuses connected via networks, downloading server 50 and trigger server 80 may be the same apparatus.

Further, it may be possible that in order for the data acquiring apparatus to acquire the latest version of software, the data acquiring apparatus transmits a model identifier to the downloading server, the downloading server transmits a list of the latest software associated with the model with a version of each software described in the list to the data acquiring apparatus, and that the data acquiring apparatus compares the list with the already installed software to download software that is not installed yet.

Furthermore, it may be possible that a server side has a database for managing a configuration of each apparatus (lot number of a used part, type and version of installed software, etc.), and when the data acquiring apparatus transmits the apparatus identifier (serial number), the server acquires information designated with the apparatus identifier from the database to compare with the latest software, and transmits only the software requiring the update to the data acquiring apparatus.

As is apparent from the above description, in the system composed of the data acquiring apparatuses, downloading server and trigger server of the present invention, each data acquiring apparatus is capable of acquiring data for updating software of the non-PC apparatus safely and efficiently via networks.

In the system of thus composed of data acquiring apparatuses, downloading server and trigger server, it is possible to decentralize data requests to the downloading server time wise or geographically, and it is thereby possible to reduce a load on a server side and to smooth data acquisition.

Further, it is possible to acquire data without disturbing the operation of the non-PC apparatus. Furthermore, when the data acquisition is urgently necessary, it is possible to acquire the data promptly.

Furthermore, even when power supply is shut down or the like occurs during data acquisition, it is possible to recover the data in the stage in which the power supply is restored.

Moreover, since the server side provides the apparatus side with information of version and registration date/time of update data and the apparatus side downloads the data only when the apparatus side requires the downloading, it is possible to reduce unnecessary data transfer.

The present invention is not limited to the above described embodiments, and various variations and modifications may be possible without departing from the scope of the present invention.

This application is based on the Japanese Patent Application No.2001-100233 filed on Mar. 30, 2001, entire content of which is expressly incorporated by reference herein.

What is claimed is:

1. A data acquiring apparatus that is installed in a non-PC apparatus connected to a network and acquires update data from a downloading server via the network, comprising;
data holding means for holding data for operating the non-PC apparatus;
requesting means for requesting the downloading server to transmit the update data corresponding to an input communication starting trigger;
acquiring means for acquiring the update data transmitted from the downloading server in response to the request;
trigger means for inputting the communication starting trigger to the requesting means; and
update means for updating the data held in the data holding means to the update data acquired by the acquiring means.

2. The data acquiring apparatus according to claim 1, wherein the trigger means inputs the communication starting trigger to the requesting means at a predetermined time every day, and the requesting means requests the downloading server to transmit the update data when the communication starting trigger is input.

3. The data acquiring apparatus according to claim 1, wherein the trigger means inputs the communication starting trigger to the requesting means at predetermined intervals, and the requesting means requests the downloading server to transmit the update data when the communication starting trigger is input.

4. The data acquiring apparatus according to claim 1, wherein the trigger means inputs the communication starting trigger to the requesting means at a time notified via the network, and the requesting means requests the downloading server to transmit the update data when the communication starting trigger is input.

5. The data acquiring apparatus according to claim 1, wherein the trigger means inputs the communication starting trigger to the requesting means at intervals notified via the network, and the requesting means requests the downloading server to transmit the update data when the communication starting trigger is input.

6. The data acquiring apparatus according to claim 1, wherein the trigger means inputs the communication starting trigger to the requesting means when trigger information for instructing to acquire the update data is notified via the network, and the requesting means requests the downloading server to transmit the update data when the communication starting trigger is input.

7. The data acquiring apparatus according to claim 1, wherein the trigger means inputs the communication starting trigger to the requesting means when trigger information for instructing to acquire the update data is notified via the network and identification information of an apparatus having notified is coincident with identification information held in advance in the data acquiring apparatus, and the requesting means requests the downloading server to transmit the update data when the communication starting trigger is input.

8. The data acquiring apparatus according to claim 1, wherein the trigger means inputs the communication starting trigger to the requesting means when it is notified via the network that the update data is stored in the downloading server, and the requesting means requests the downloading server to transmit the update data when the communication starting trigger is input.

9. The data acquiring apparatus according to claim 1, wherein when the requesting means requests the downloading server to transmit the update data, the requesting means notifies the downloading server of at least one of a model of the non-PC apparatus, a serial number of the non-PC apparatus, a model number of the non-PC apparatus, and an address of the data acquiring apparatus on the network.

10. The data acquiring apparatus according to claim 1, wherein when the non-PC apparatus is operating at the time the communication starting trigger is input to the requesting means, the requesting means requests the downloading server to transmit the update data after the non-PC apparatus stops operating.

11. The data acquiring apparatus according to claim 1, wherein when the non-PC apparatus is operating at the time the communication starting trigger is input to the requesting means, the requesting means requests the downloading server to transmit the update data after a time-out time elapses after the communication starting trigger is input.

12. The data acquiring apparatus according to claim 1, wherein the requesting means decreases the time-out time as the update data has a higher priority.

13. The data acquiring apparatus according to claim 1, further comprising:
an interface on which a detachable recording medium storing the update is mounted,
wherein when the recording medium is mounted on the interface, the acquiring means acquires the update data from the recording medium.

14. The data acquiring apparatus according to claim 13, wherein when the recording medium is mounted on the interface and identification information stored in the recording medium is coincident with identification information stored in advance in the data acquiring apparatus, the acquiring means acquires the update data from the recording medium.

15. The data acquiring apparatus according to claim 13, wherein when the recording medium is mounted on the interface and the update data stored in the recording medium is newer than the data held in the data holding means, the acquiring means acquires the update data from the recording medium.

16. The data acquiring apparatus according to claim 1, wherein when the update data in the downloading server is newer than the data held in the data holding means, the requesting means requests the downloading server to transmit the update data.

17. The data acquiring apparatus according to claim 1, wherein when the update data acquired by the acquiring means is newer than the data held in the data holding means, the update means updates the data held in the data holding means to the update data acquired by the acquiring means.

18. The data acquiring apparatus according to claim 1, further comprising:
state holding means for holding a progress state of a series of processing for updating the data,
wherein when power is supplied to the non-PC apparatus, the processing for updating the data is started corresponding the progress state held in state holding means.

19. The data acquiring apparatus according to claim 18, wherein the state holding means keeps holding the progress state of the series of processing for updating the data even when power supply to the data acquiring apparatus is stopped.

20. The data acquiring apparatus according to claim 1, further comprising:
backup means for saving as backup the data held in the data holding means before the data is updated by the updating means, and when the non-PC apparatus does not start normally, restores the data saved to the data holding means.

21. The data acquiring apparatus according to claim 1, wherein the requesting means requests the downloading server at an address on the network notified via the network to transmit the update data.

22. A downloading server that transmits update data to a non-PC apparatus via a network, comprising:
receiving means for receiving an update data request transmitted from the non-PC apparatus;
storing means for storing the update data;
reading means for reading from the storing means the update data corresponding to the non-PC apparatus having transmitted the update data request when the update data request is received in the receiving means; and
transmitting means for transmitting the update data read in reading means to the non-PC apparatus having transmitted the update data request.

23. The downloading server according to claim 22, further comprising:
first managing means for bringing the update data stored in the storing means into correspondence with at least one of a model of the non-PC apparatus, a serial number of the non-PC apparatus, and a model number of the non-PC apparatus to manage,
wherein the reading means reads update data specified based on information notified from the non-PC apparatus and on the correspondence in the first managing means, as the update data corresponding to the non-PC apparatus having transmitted the update data request.

24. The downloading server according to claim 22, wherein the receiving means receives the update data via the network, and the storing means stores the update data received in the receiving means.

25. The downloading server according to claim 22, further comprising:
first notifying means for notifying the non-PC apparatus having transmitted the update data request of an address of another downloading server on the network so as to make the non-PC apparatus change a destination of the update data request to the another downloading sever.

26. The downloading server according to claim 25, further comprising:
second managing means for bringing a serial number of the non-PC apparatus into correspondence with a location area of the non-PC apparatus to manage; and
third managing means for bringing an area to which the downloading server transmits the update data into correspondence with an address of the downloading server on the network to manage;
wherein the first notifying means notifies the non-PC apparatus having transmitted the update data request of the address of the another downloading server specified based on an address of the non-PC address on the network notified from the non-PC apparatus, the correspondence in the second managing means and the correspondence in the third managing means.

27. The downloading server according to claim 22, further comprising:
second notifying means for notifying the non-PC apparatus of a time during a time period with the least number of update data requests received in the receiving means.

28. The downloading server according to claim 22, further comprising:
third notifying means for notifying the non-PC apparatus of an interval at which the update data received in the receiving means via the network is stored in the storing means.

29. The downloading server according to claim 22, further comprising:
fourth notifying means for notifying the non-PC apparatus of a version of the update data stored in the storing means.

30. The downloading server according to claim 22, further comprising:
fifth notifying means for notifying the non-PC apparatus of a date and time at which the update data received in the receiving means via the network is stored in the storing means.

31. A trigger server that instructs via a network a non-PC apparatus to acquire update data from a downloading server, comprising:
detecting means for detecting that the update date is stored in the downloading server; and
trigger information transmitting means for transmitting trigger information for instructing the non-PC apparatus to acquire the update data from the downloading server to the non-PC apparatus when the detecting means detects that the update data is stored in the downloading server.

32. The trigger server according to claim 31, wherein the trigger information transmitting means transmits the trigger information to a plurality of non-PC apparatuses at different times with a predetermined interval.

33. The trigger server according to claim 31, wherein the trigger information transmitting means transmits the trigger information to a plurality of non-PC apparatuses at random.

34. The trigger server according to claim 31, wherein when the non-PC apparatus having received the trigger information has not requested the downloading server to transmit the update data, the trigger information transmitting means retransmits the trigger information the non-PC apparatus.

35. The trigger server according to claim 31, wherein the trigger information transmitting means transmits the trigger information sooner, as the update data corresponding to the trigger information has a higher priority.

36. The trigger server according to claim 31, wherein the trigger information transmitting means transmits the trigger information containing a time of starting communicating with the downloading server.
